(19) United States
(12) Patent Application Publication
(10) Pub. No.: US 2010/0060650 A1
(43) Pub. Date: Mar. 11, 2010

(54) MOVING IMAGE PROCESSING METHOD, MOVING IMAGE PROCESSING PROGRAM, AND MOVING IMAGE PROCESSING DEVICE

(75) Inventor: Toshihiko Yamakami, Chiba (JP)

Correspondence Address: MORRISON & FOERSTER LLP, 425 MARKET STREET, SAN FRANCISCO, CA, 94105-2482, US

(73) Assignee: Access Co., Ltd., Chiyoda-ku (JP)

(21) Appl. No.: 12/525,075

(22) PCT Filed: Jan. 28, 2008
(86) PCT No.: PCT/JP2008/051183

§ 371 Date: Jul. 29, 2009

(30) Foreign Application Priority Data
Jan. 29, 2007 (JP) 2007-017488

(51) Int. Cl. G06T 15/70; G06F 17/00

(52) U.S. Cl. 345/474; 715/234

(57) ABSTRACT

A moving image processing method includes: an operation item setting step of setting operation items to be operated on the moving image; a time interval setting step of setting which time interval in a reproducing period of the moving image should be defined as an interval in which the operation items that have been set are executable; a display area setting step of setting display areas for images for operations corresponding to the operation items that have been set; an image combining step of combining the images for operations corresponding to the operation items that have been set with the respective frame images, in accordance with the time interval setting step and the display area setting step; and an associating step of associating, with each combined frame image, information concerning the display areas of the images for operations in the frame image and information concerning the operation items, and storing each combined frame image and the associated information.

### TECHNICAL FIELD

The present invention relates a moving image processing method, a moving image processing program, and a moving image processing device to process a moving image which includes plural flame images sequentially switched with respect to time.

### BACKGROUND OF THE INVENTION

Information browsing software for browsing information on a network (hereinafter, written as “browser”) is widely known and provided for practical use. A browser analyses information on a network (a Web page, for example, a document described in a markup language such as an HTML (Hyper Text Markup Language)), performs rendering based on the result of the analysis, and lets a display of a terminal device indicate the Web page.

For example, by putting a predetermined description in a document described in a markup language such as an HTML, it is possible to realize a function corresponding to the predetermined description on a browser. As one of such functions, for example, there exists a clickable map, which is disclosed in the Japanese Patent Provisional Publication No. 2006-178621. A clickable map is a function to access a linked target, which is assigned to a predetermined image, when, for example, the predetermined image displayed on a Web page is clicked. By adopting a clickable map, it is possible, for example, to assign a different linked target to each of portions contained in one image (for example, each country contained in one world map).

### DISCLOSURE OF THE INVENTION

The above clickable map is a function which has been invented for processing static images. However, a function to assign a different link to each portions of one image can be considered as an advantageous function not only for static images but also for moving images.

As a method of introducing a clickable map function to a moving image, for example, it can be considered to apply a clickable map to each frame image consisting the moving image. In this case, however, it is necessary to add descriptions of a clickable map to all of the frame images. Thus there exists a problem, for example, that development of moving image data is complicated.

The present invention has been invented in view of the aforementioned circumstances. Namely, it is an object of the present invention to provide a moving image processing method, a moving image processing program, and a moving image processing device which are advantageous to realize various operation functions which are realized on a moving image, such as the operation function of the clickable map described above.

To solve the above described problem, according to an embodiment of the invention, there is provided a moving image processing method of processing a moving image including plural flame images sequentially altering with respect to time, including: an operation item setting step of setting operation items to be operated on the moving image; a time interval setting step of setting which time interval in a reproducing period of the moving image should be defined as an interval in which the operation items that have been set are executable; a display area setting step of setting display areas for images for operations corresponding to the operation items that have been set; an image combining step of combining the images for operations corresponding to the operation items that have been set with the respective frame images, in accordance with the time interval setting step and the display area setting step; and an associating step of associating, with each combined frame image, information concerning the display areas of the images for operations in the frame image and information concerning the operation items, and storing each combined frame image and the associated information.

According to the moving image processing method configured in this manner, since it is not necessary to consider each frame forming the moving image when an operation function is added to the moving image, it is extremely easy to add an operation function.

The moving image processing method may further include: an image selecting step of selecting the images for operations displayed on the moving image; and a process executing step of executing processes corresponding to the selected images for operations.

The image selecting step may include: a frame image specifying step of specifying, when a certain position on the moving image is selected by a user operation, the selected frame image based on timing of the selection; a comparing step of comparing the information concerning the display area associated with the specified frame image with the information concerning the selected position; and an image specifying step of specifying the image for the operation selected by the user operation based on the information concerning the operation items associated with the information concerning display areas, when it is determined by a result of the comparison that the selected position is contained in the display area.

In the above associating step, for each combined frame image, information about selectable areas in the frame image excluding the display areas for the images for operations may be associated, and the associated information is stored. In the above comparing step, the information about selectable areas, which is associated with the specified frame image, may be further compared with the information about the selected position. In the above image specifying step of specifying the image for the operation selected by the user operation, when it is determined that the selected position is contained in the selectable areas by the result of the comparison, it may be judged that the selected position is contained in the display area.

In the process executing step, one of altering the display mode of the moving image, changing the position of reproduction of the moving image, switching the moving image to be reproduced, and transmitting a request to an external device, may be executed in accordance with the images for the operations which have been selected in the image selecting step.

In the associating step, predetermined link information may be further associated and may be stored. When a predetermined image for an operation is selected in the image selecting step, then in the process executing step, a linked target may be accessed by referring to the link information, and contents of the linked target may be retrieved and displayed.

In the moving image processing method, the operation item setting step, the time interval setting step, and the display area setting step may be executed based on predetermined rules.

In the moving image processing method, when there are plural moving images to be processed, then in the associating step, moving image identifying information for identifying each moving image may be further associated and stored, and in the image selecting step, the moving image containing the image for the operation selected by the user operation may be specified based on the moving image identifying information.

Plural images for operations corresponding to the operation items may exist, and in the image combining step, for the frame images corresponding to the time interval in which the operation items are executable, and for the frame images corresponding to the time interval in which the operation items are not executable, the images for operations corresponding to the different operation items may be combined, respectively. Further, the contents may include Web contents.

To solve the above described problem, according to another embodiment of the invention, there is provided a moving image processing method of processing a moving image including plural frame images sequentially altering with respect to time, including: an operation item setting step of setting operation items to be operated on the moving image; a time interval setting step of setting which time interval in a reproducing period of the moving image should be defined as an interval in which the operation items that have been set are executable; and an associating step of associating information about the operation items that have been set with each frame image corresponding to the time interval that has been set, and storing the associated information.

The moving image processing method may further include: a frame image specifying step of specifying a frame image corresponding to a timing of a click when a part of the moving image is clicked by a user operation, based on the timing in which the click is made; and a process executing step for executing processes corresponding to the information about the operation items which has been associated with the specified frame image.

The moving image processing method may further include: an image effect adding step of adding effects, which designate that the operation items are executable, to the frame images corresponding to the time interval that has been set or a time interval having a predetermined relationship with the time interval that has been set.

The moving image processing method may further include an audio effect adding step of adding predetermined audios to the moving image or adding predetermined effects to audios associated with the moving image, in the time interval that has been set or in the time interval having a predetermined relationship with the time interval that has been set.

To solve the above described problem, according to another embodiment of the invention, there is provided a moving image processing method of processing a moving image including plural frame images sequentially altering with respect to time, including: a moving image generating step of generating a moving image based on contents; an operation item setting step of setting operation items to be operated on the generated moving image; a time interval setting step of setting which time interval in a reproducing period of the moving image should be defined as an interval in which the operation items that have been set are executable; a display area setting step of setting display areas for images for operations corresponding to the operation items that have been set; an image combining step of combining the operation images corresponding to the operation items that have been set with the respective frame images, in accordance with settings by the time interval setting step and the display area setting step; and an associating step of associating, with each combined frame image, information concerning the display areas of the images for operations in the frame image and information concerning the operation items, and storing each combined frame image and the associated information.

The moving image generating step may include: a content designating step of designating plural contents used for the moving image; a content collecting step of collecting each designated content; a content image generating step of generating content images based on the collected contents; a display mode setting step of setting a mode for displaying each generated content image; and a generating step of generating the moving image such that each content image is changed in a chronological order based on the display mode that has been set.

In the moving image processing method, the contents may include information that can be displayed. The contents may include Web contents.

In the moving image processing method, the Web contents may be Web pages. In this case, in the content image generating step, the collected Web pages may be analyzed, and the content images may be generated based on a result of the analysis.

To solve the above described problem, a moving image processing program causes a computer to execute the above moving image processing method.

According to the moving image processing program configured in this manner, since it is not necessary to consider each frame image consisting the moving image when an operation function is added to the moving image, it is extremely easy to add an operation function.

To solve the above described problem, according to an embodiment of the invention, there is provided a moving image processing device for processing a moving image including plural flame images sequentially altering with respect to time, including: an operation item setting means that sets operation items to be operated on the moving image; a time interval setting means that sets which time interval in a reproducing period of the moving image should be defined as an interval in which the operation items that have been set are executable; a display area setting means that sets display areas for images for operations corresponding to the operation items that have been set; an image combining means that combines the operation images corresponding to the operation items that have been set with the respective frame images, in accordance with the settings of the time interval setting means and the display area setting means; and an associating means that associates, with each combined frame image, information concerning the display areas of the images for operations in the frame image and information concerning the operation items, and stores each combined frame image and the associated information.

According to the moving image processing device configured in this manner, since it is not necessary to consider each frame consisting the moving image when an operation function is added to the moving image, it is extremely easy to add an operation function.

The moving image processing device may further include: an image selecting means that selects the images for the operations displayed on the moving image, and a process executing means that executes processes corresponding to the selected images for the operations.

The image selecting means is configured such that: when a certain position on the moving image is selected by a user operation, the selected frame image is specified based on timing of the selection; the information about the display area which is associated with the specified frame image and the information about the selected position are compared; and when it is judged by a result of the comparison that the selected position is contained in the display area, the images for the operations that have been selected by the user operation are specified based on the information about the operation items which is associated with the information about the display area.

The associating means may be configured such that for each combined frame image, information about selectable areas in the frame image excluding the display areas for the images for operations is associated, and the associated information is stored. The comparing means may further compare the information about selectable areas which is associated with the specified frame image with the information about the selected position. The image selecting means may determine that the selected position is contained in the display area when it is determined by a result of the comparison that the selected position is contained in the selectable areas.

The process executing means may be configured to execute one of altering the display mode of the moving image, changing the position of reproduction of the moving image, switching the moving image, and transmitting a request to an external device in accordance with the images for the operations which have been selected by the image selecting means.

The associating means may further associate predetermined link information and stores the information. When a predetermined image for an operation is selected by the image selecting means, the process executing means may refer to the link information and accesses a linked target, and the process executing means may retrieve contents on the linked target and displays the contents.

The moving image processing device may further include a storing means that stores setting rules of setting operation items to be operated on the moving image, setting a time interval in which the operation items are executable, and setting display areas for the operation items. The operation item setting means, the time interval setting means, and the display area setting means may be configured to execute setting process based on the setting rules.

In the moving image processing device, when plural images to be processed exist, then the associating means may associate moving image identifying information for identifying each moving image and store the associated moving image identifying information, and the image selecting means may specify the moving image containing the image for the operation selected by the user operation, based on the moving image identifying information.

Plural images for operations corresponding to the operation items may exist. The combining means may combine, with the frame images corresponding to the time interval in which the operation items are executable and the frame images corresponding to the time interval in which the operation items are not executable, the images for operations corresponding to the different operation items, respectively. The contents may include Web contents.

To solve the above described problem, according to another embodiment of the invention, there is provided a moving image processing device for processing a moving image including plural frame images sequentially altering with respect to time, including: an operation item setting means that sets operation items to be operated on the moving image; a time interval setting means that sets which time interval in a reproducing period of the moving image should be defined as an interval in which the operation items that have been set are executable; and an associating means that associates each frame image corresponding to the time interval that has been set with the information about the operation items that have been set.

The moving image processing device may further include: a frame image specifying means that specifies a frame image corresponding to a timing of a click, when a part of the moving image is clicked by a user operation, based on the timing in which the click is made; and a process executing means that executes processes corresponding to the information about the operation items which has been associated with the specified frame image.

The moving image processing device may further include an image effect adding means that adds effects, which designate that the operation items are executable, to the frame images corresponding to the time interval that has been set or a time interval having a predetermined relationship with the time interval that has been set.

The moving image processing device may further include an audio effect adding means that adds predetermined audios to the moving image or adds predetermined effects to audios associated with the moving image, in the time interval that has been set or in the time interval having a predetermined relationship with the time interval that has been set.

To solve the above described problem, according to another embodiment of the invention, there is provided a moving image processing device for processing a moving image including plural flame images sequentially altering with respect to time, including: a moving image generating means that generates a moving image based on contents; an operation item setting means that sets operation items to be operated on the generated moving image; a time interval setting means that sets which time interval in a reproducing period of the moving image should be defined as an interval in which the operation items that have been set are executable; a display area setting means that sets display areas for images for operations corresponding to the operation items that have been set; an image combining means that combines the operation images corresponding to the operation items that have been set with the respective frame images, in accordance with the settings of the time interval setting means and the display area setting means; and an associating means that associates, with each combined frame image, information concerning the display areas of the images for operations in the frame image and information concerning the operation items, and stores each combined frame image and the associated information.

The moving image processing device may further include: a content designating means that designates plural contents used for the moving image; a content collecting means that collects each designated content; a content image generating means that generates content images based on the collected contents; and a display mode setting means that sets a mode for displaying each generated content image. In this case, the moving image generating means generates a moving image in which each content image sequentially changes with respect to time based on the display mode which has been set.

In the moving image processing device, the contents may include information which can be displayed. The contents may include Web contents.

In the moving image processing device, the Web contents may be Web pages. In this case, the content image generating means may analyze the collected Web pages, and generate the content images based on a result of the analysis.

According to the embodiments of the present invention, a moving image processing method, a moving image processing program, and a moving image processing device, with which it is extremely easy to add an operation function to a moving image, because it is not necessary to consider each frame image consisting the moving image when an operation function is added to the moving image, are provided.

### BRIEF DESCRIPTION OF THE DRAWINGS

FIG. 1 is a block diagram illustrating a configuration of a moving image distributing system according to an embodiment of the invention.

FIG. 2 is a block diagram illustrating a configuration of a moving image generating server according to an embodiment of the invention.

FIG. 3 illustrates process pattern data stored in an HDD of a moving image generation server according to an embodiment of the invention.

FIG. 4 illustrates process pattern updating data stored in an HDD of a moving image generation server according to an embodiment of the invention.

FIG. 5 is a block diagram illustrating a configuration of a Web server according to an embodiment of the invention.

FIG. 6 is a functional block diagram illustrating a part of a content retrieving program according to an embodiment of the invention.

FIG. 7 is a flowchart illustrating a generating structure information determination process executed by a moving image generating program according to an embodiment of the invention.

FIG. 8 illustrates an example of a moving image generated in an embodiment of the invention.

FIG. 9 illustrates effect process pattern data stored in an HDD of a moving image generating server according to an embodiment of the invention.

FIG. 10 is a flowchart illustrating a moving image generating process executed by a moving image generating program according to an embodiment of the invention.

FIG. 11 illustrates an example of changeover patterns according to an embodiment of the invention.

FIG. 12 illustrates an example of a three-dimensional dynamic frame pattern according to an embodiment of the invention

FIG. 13 is a flowchart illustrating a moving image generating process executed by a moving image generating program according to a second embodiment of the invention.

FIG. 14 illustrates an example of a Web page which provides a real-time service situation by text.

FIG. 15A illustrates a route map as basic graphic/audio data according to a second embodiment of the invention.

FIG. 15B illustrates a content image made from the route map of FIG. 15A and the service information of FIG. 14 according to a second embodiment of the invention.

FIG. 16 is a flowchart illustrating an interactive moving image generating process executed by a moving image generating program according to a third embodiment of the invention.

FIG. 17 illustrates an example of a moving image with operation buttons generated in a third embodiment of the invention.

FIG. 18 is a flowchart illustrating a moving image operating process executed between a home server and a terminal device according to a third embodiment of the invention.

FIG. 19A illustrates a frame image of an interactive moving image with operation buttons according to a first modification of a third embodiment of the invention.

FIG. 19B illustrates a frame image of an interactive moving image with operation buttons according to a second modification of a third embodiment of the invention.

FIG. 20 is a flowchart illustrating an interactive moving image generating process according to a fourth embodiment of the invention.

FIG. 21 illustrates an example of screen transition of an interactive moving image according to a fourth embodiment of the invention.

FIG. 22 illustrates an example of screen transition of an interactive moving image according to a fourth embodiment of the invention.

### BEST MODE FOR CARRYING OUT THE INVENTION

In the following, an embodiment according to the present invention is described with reference to the accompanying drawings.

First, terms used in this specification are defined.

### Network

Various communications networks include computer networks including LANs or the Internet, telecommunications networks (including mobile communications networks), and broadcast networks (including cable broadcast networks), etc.

### Content:

A bundle of information includes video and images, audio, text, or combination thereof, which is transmitted through a network, or stored in a terminal.

### Web Content:

A form of a content. A bundle of information transmitted through a network.

### Web Page:

A form of a Web content. The whole contents to be displayed when a user specifies a URI (Uniform Resource Identifier). Namely, the whole contents to be displayed by scrolling an image on a display. Web pages include not only web pages that can be browsed online but also web pages that can be browsed offline. Web pages that can be browsed offline include, for example, a page transmitted through a network and cached by a browser, or a page stored in a local folder, etc., of a terminal device in mht format. A Web page consists of, for example, text files described in a markup language such as an HTML document, etc., image files, various data (Web page data) such as audio data.

### Moving Image:

Information including a time concept, and includes, for example, a group of still images which are sequentially switched with respect to time without requiring an external input by a user, etc.

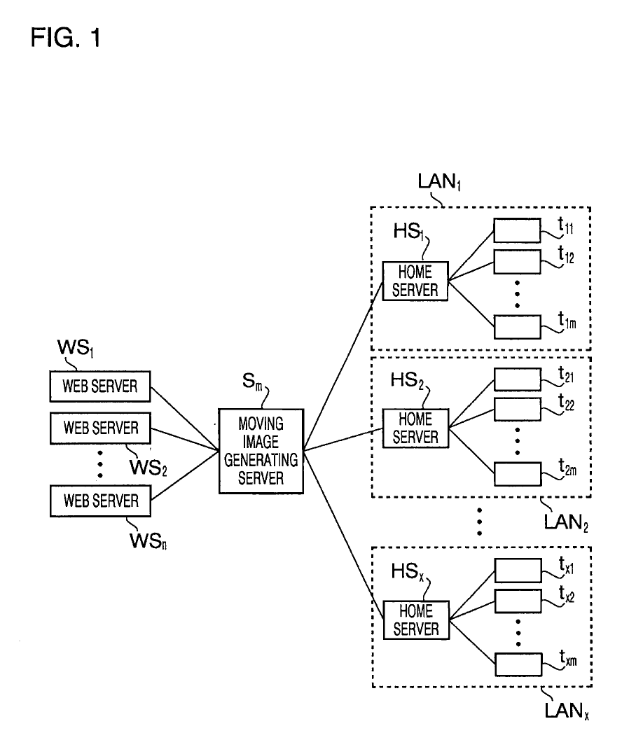

FIG. 1 is a block diagram illustrating a configuration of a moving image distributing system according to an embodiment of the invention. The moving image distributing system according to an embodiment of the invention includes plural Web servers WS₁-WSₙ, a moving image generating server Sₘ, and plural LAN (Local Area Network)₁-LANₓ, which are interconnected through the Internet. Further, in another embodiment of the present invention, other networks such as broadcast networks can be utilized instead of the Internet or LANs.

The moving image generating server Sₘ collects information on networks based on a predetermined scenario. Next, the moving image generating server Sₘ generates moving images based on the collected information. And the moving image generating server Sₘ distributes the generated moving images to clients. Further, in this specification, the scenario means a rule for generating information (moving images) suitable for “viewing while doing something else.” Specifically, the scenario is, for example, a rule for defining processing method, such as defining which information on the networks is to be collected, and defining how to process the information collected and generate moving images. The scenario is realized by a program defining these processes and data utilized by the program.

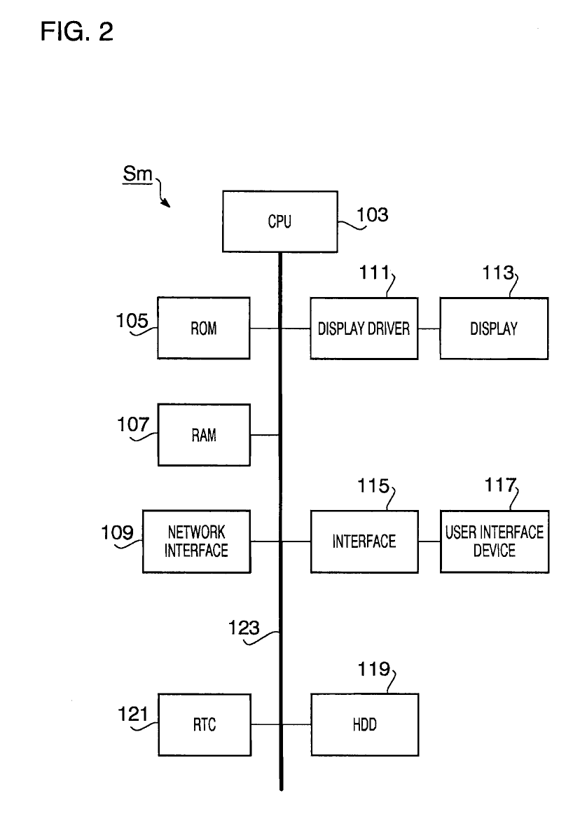

FIG. 2 is a block diagram illustrating a configuration of the moving image generating server Sₘ. As shown in FIG. 2, the moving image generating server Sₘ includes a CPU 103 which integrally controls the entirety of the server Sₘ. The CUP 103 is connected to each component through a bus 123. The components essentially include a ROM (Read-Only Memory) 105, RAM (Random-Access Memory) 107, a network interface 109, a display driver 111, an interface 115, an HDD (Hard Disk Driver) 119, and RTC (Real Time Clock) 121. A display 113 and a user interface device 117 are connected to the CPU through the display driver 111 and the interface 115, respectively.

Various programs and various pieces of data are stored in the ROM 105. Programs stored in the ROM 105 include, for example a content retrieving program 30, and a moving image generating program 40 which cooperates and works with the content retrieving program 30. As a result that these programs mutually cooperate and work together, moving images are generated in accordance with the scenario. Further, data stored in the ROM 105 include, for example, data used by various programs. Such data include, for example, data used by the content retrieving program 30 and data used by the moving image generating program 40, in order to realize the scenario. Furthermore, in the embodiment, the content retrieving program 30 and the moving image generating program 40 are different programs, but in another embodiment, these programs can be configured to form a single program.

For example, in the RAM 107, programs, data, or results of operations that have been read in from the ROM 105 by the CPU 103 are temporarily stored. As long as the moving image generating server Sₘ are working, various programs such as the content retrieving program 30 and the moving image generating program 40 are, for example, in a state in which these programs are expanded and reside in the RAM 107. Therefore, the CPU 103 can execute these programs anytime and can generate and send out a dynamic response in response to a request from a client. Further, the CPU 103 keeps monitoring the time measured by the RTC 121. Furthermore, the CPU 103 executes these programs, for example, each time the time measured coincides with a predetermined time (or the measured time elapses a predetermined time). For example, the CPU 103 executes the content retrieving program 30 and operates to access a designated URI and to retrieve a content, each time the time measured elapses the predetermined time. Hereinafter, for the ease of the explanation, the timing for executing the content retrieving program 30 and accessing the content is written as “the access timing.” Further, in the embodiment, it is assumed and explained that a content retrieved by accessing each URI is a Web page.

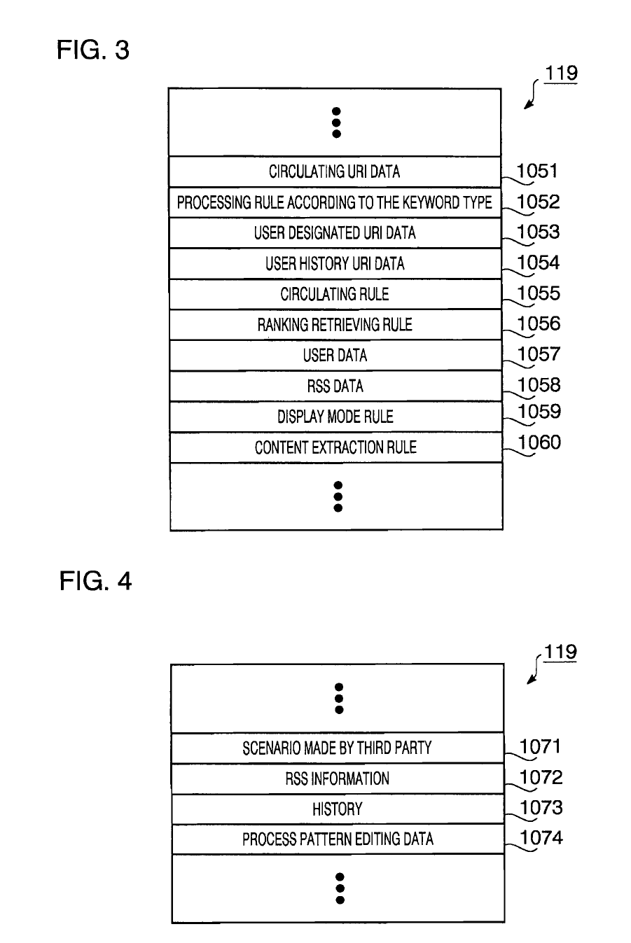

Process pattern data is stored in the HDD 119. The process pattern data is data for realizing the scenario, and the process pattern data is necessary for the content retrieving program 30 to retrieve various contents on networks. The process pattern data stored in the HDD 119 is shown in FIG. 3.

As it is shown in FIG. 3, the HDD 119 stores, as the process pattern data, circulating URI (Uniform Resource Identifier) data 1051, a processing rule according to the keyboard type 1052, user designated URI data 1053, user history URI data 1054, a circulating rule 1055, a ranking retrieving rule 1056, a terminal processing status rule 1057, RSS (Rich Site Summary) data 1058, display mode data 1059, and a content extraction rule 1060. Further, the process pattern data described here is an example, various other types of process pattern data are assumed.

The following are explanations of each processing pattern data.

### The Circulating URI Data 1051

The data for designating a URI which is accessed at the timing for accessing by the content retrieving program 30. For example, a Web page with high versatility (for example, a Web page for providing a national version of an weather forecast) is designated. A URI to be designated can be added, for example, through a user operation.

### The Processing Rule According to the Keyword Type 1052

The data, which is associated with each URI, for managing all the URIs (or specific URIs) contained in the cyclic URI data 1051 by classifying the URIs according to each predetermined keyword. For example, when a URI is newly added to the circulating URI data 1051, its classification can be specified, for example, by a user operation.

### The User Designated URI Data 1053

The data for designating a URI which is accessed at the timing for accessing by the content retrieving program 30. Here, for example, a Web page reflecting an end user's request or preference (for example, a Web page providing an weather forecast for an area in which the end user lives) is designated based on a request from a client. The designated URI is added, for example, when the request from the client is received.

### The User History URI Data 1054

The data designating a URI which is accessed by the content retrieving program 30 at the timing for accessing. Here, for example, the Web page retrieved from a URI history, which is sent from a client, is designated. The URI history is added, for example, when the URI history is received from the client.

### The Circulating Rule

The data for specifying an order and timing for circulating all the URIs (or specific URIs) contained in the circulating URI data 1051.

### The Ranking Retrieving Rule 1056.

The data for retrieving an access ranking of a Web content, which is published on search engines. The data includes, for example, an address of the search engine of the retrieval, the timing for retrieving the access ranking.

### The User Data 1057

Information about each end user (here, the users of LAN₁-LANₓ) who receives the service (moving images) provided from the moving image generating server Sₘ. The user data 1057 includes, for example, a profile of the end user (for example, the name or the address), a specification of the terminal device with which the moving images are reproduced, and a registration scenario. Further, the user data 1057 is associated with the user designated URI data 1053 and the user history URI data 1054. By this data, information management for each end user is realized.

### The RSS Data 1058

The data for designating URIs to be circulated by an RSS reader which is embedded in the content retrieving program 30. The designated URI can be added, for example, by a user operation.

### The Display Mode Rule 1059

The data describing the rules for a display order of Web contents, layouts of the Web contents, and displaying time and switching time for each Web content, for all the reproduction time of the moving image. Further, the display mode rule 1059 includes data for individually specifying the display order, the layouts, the displaying time and switching time, respectively. Further, according to the rules for the display order, the display order is determined according to, for example, the order of circulation determined by the circulating rule 1055 or the RSS data 1058, the history of the user history URI data 1054, the ranking retrieved based on the ranking retrieving rule 1056, or the combination thereof. Further, in the rule for the layout, it is assumed that plural small screens are displayed on the moving image using a flame pattern 2061 described below. The content assigned to each small screen is determined by the rule for the layout. For example, in the case in which there are two small screens to be displayed on the moving image (denoted as “the small screen 1,” and “the small screen 2,” respectively), the rule for the layout can be “a news site (for example, the URI classified and managed by the keyword “news” in the processing rule according to the keyword type 1052) is displayed on the small screen 1, the URI designated by a use is displayed on the small screen 2.” Further, the rule for displaying time is for determining the displaying time for each content to be displayed on the moving image. Furthermore, the rule for switching time is for determining the time spent for switching the contents to be displayed on the moving image.

### The Content Extraction Rule 1060

The data describing the rule for extracting specific elements of the Web content that has already been retrieved, or the rule for extracting and retrieving specific elements of a Web content on a network. As an example, there is one for extracting and retrieving the element which is broadcasted on a headline of a news site (for example, class=“yjMT” or class=“yjMT s150”).

Further, the process pattern updating data is also stored in the HDD 119. The process pattern updating data is a data for realizing the scenario, its objective is to give dynamic changes to the process pattern data. In FIG. 4, the process pattern updating data stored in the HDD 119 is shown.

As it is shown in FIG. 4, the HDD 119 stores, as the process pattern updating data, for example, a scenario made by a third party 1071, RSS information 1072, a history 1073, and process pattern editing data 1074. Further, the process pattern updating data described here is just an example, various other types of process pattern updating data is assumed.

The following are explanations of each process pattern updating data.

### The Scenario Made by a Third Party 1071.

For example, scenarios made by an administrator of the moving image generating server Sₘ or a third party. It can be updated by an operation of the administrator. Further, it is possible to update by replacing a scenario with the scenario made by the third party.

### The RSS Information 1072

The RSS information retrieved by the RSS reader.

### The History 1073

The URI history sent from the client.

### The Process Pattern Editing Data 1074

The patch data for editing the process pattern data. For example, it can be made by a user operation.

Next, the process in which the content retrieving program 30 retrieves a content (here, a Web content) from each URI is explained. As an example of a content retrieval, for example, a content retrieval based on the scenario made by a third party 1071, or a content retrieval based on the scenario, which is contained in the terminal processing status data 1057, registered by an end user can be considered. Here, the content retrieval based on the scenario made by a third party 1071 is explained as an example.

The content retrieving program 30 determines the URI to be accessed based on the scenario made by a third party 1071 stored in the RAM 107. Here, it is assumed that the scenario made by a third party 1071 is described so that each URI managed with the keyword “economy” is to be accessed, for example, in the processing rule according to the keyword type 1052. In this case, the content retrieving program 30 retrieves each URI, which is associated with the keyword “economy” in the circulating URI data 1051. Next, each URI retrieved is accessed.

It is supposed, in this case, that one of the designated URIs retrieved includes, for example, the Web page of the Web server WS₁. In this case, the content retrieving program 30 operates to retrieve the data of the Web page (here, an HTML (Hyper Text Markup Language) document 21) from the Web server WS₁.

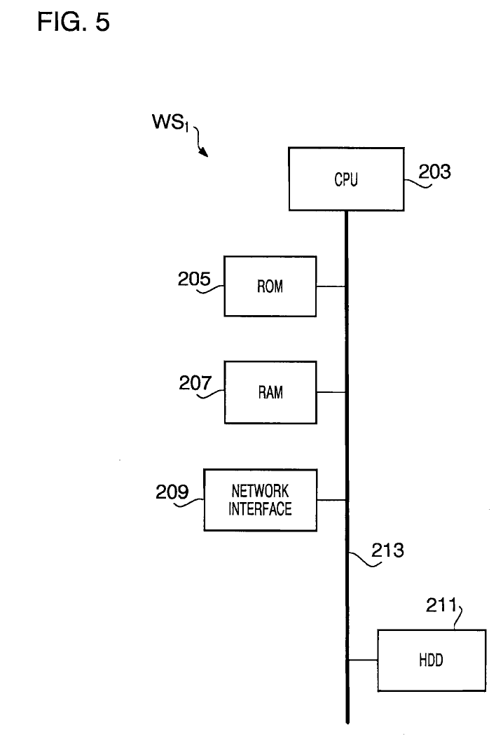

FIG. 5 shows the block diagram of the configuration of the Web server WS₁. As it is shown in FIG. 5, the Web server WS₁ includes the CPU 203, which integrally controls the entirety of the Web server WS₁. Each component is connected to the CPU 203 through the bus 213. These components include the ROM 205, the RAM 207, the network interface 209, and the HDD 211. The Web server WS₁ can communicate with each device on the Internet through the network interface 209.

Further, the Web servers WS₁-WSₙ are PCs (Personal Computers), known to everybody, in which Web data to be provided to clients are stored. Each of the Web servers WS₁-WSₙ in the embodiment are different only in terms of Web page data to be distributed, and they are substantially the same in terms of their configurations. Hereinafter, in order to avoid overlapping of explanations, the explanation of the Web server WS₁ represents the explanations for the other Web servers WS₂-WSₙ.

In the ROM 205, various programs and data are stored so as to execute a process corresponding to a request from a client. These programs are, as long as the Web server WS₁ is activated, expanded and reside in the RAM 207, for example. Namely, the Web server WS₁ keeps monitoring whether there is a request from a client or not. And, if there is a request, then the Web server WS₁ executes the process corresponding to the request immediately.

The Web server WS₁ stores various Web page data including the HTML document 21 to be published on the Internet. The Web server WS₁ reads out, for example, after receiving the request for retrieving the HTML document 21 from the content retrieving program 30, a Web page corresponding to the designated URI (namely, a document described in a predetermined markup language, the HTML document 21, for example) from the HDD 211. Next, the HTML document 21 which has been read out is sent to the moving image generating server Sₘ.

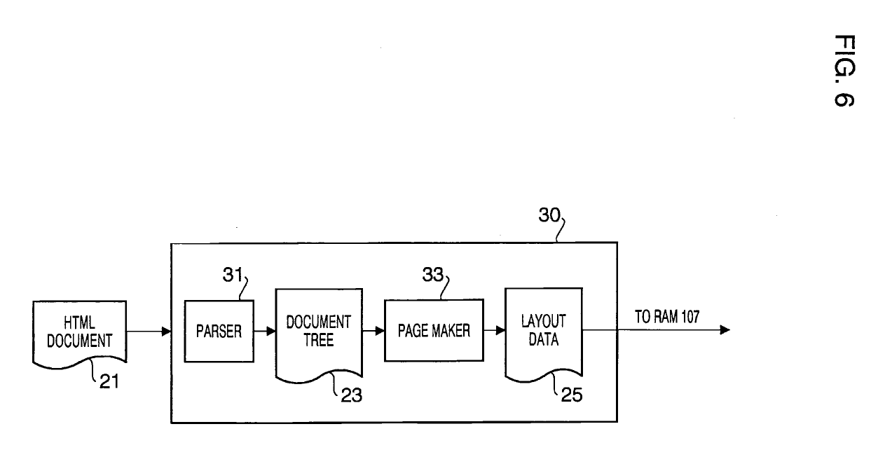

In FIG. 6, main functions of the content retrieving program 30 are shown as a functional block diagram. As it is shown in FIG. 6, the content retrieving program 30 includes each functional block corresponding to a parser 31 and a page maker 32.

The HTML document 21 which has been sent from the Web server WS₁ is received by the moving image generating server Sₘ through the Internet, and it is passed to the parser 31.

The parser 31 analyzes the HTML document 21, and based on the result of the analysis, generates a document tree 23 in which the document structure of the HTML document 21 is represented in terms of the tree structure. Further, the document tree 23 is merely representing the document structure of the HTML document 21, it does not include the information about expressions of the document.

Next, the page maker 32 generates a layout tree 25 including the form of expression of the HTML document 21, for example block, incline, table, list, item, etc., based on the document tree 23 and information about tags. Further, the layout tree 25 includes, for example, an ID and coordinates for each element. The layout tree 25 is representing in which order the block, the inline, the table, etc., are existing. However, the layout tree does not include information about where on the screen of the terminal device, and with what width and what height, these elements (the block, the inline, the table, etc.) are displayed, or information about from which part characters are folded.

The layout tree for each Web page made by the page maker 32 is stored in the area for layout trees in the RAM 107 with the state in which the layout tree is associated with the time of retrieval (hereinafter, written as “the content retrieval time”). Furthermore, the content retrieval time can be retrieved from the measured time of the RTC 121.

Further, the content retrieving program 30 accesses each URI in accordance with the predetermined order and timing specified, for example, by the circulating data 1055, and retrieves each Web page data sequentially. Furthermore, the content retrieving program 30 generates and stores each layout tree by the same process described above.

Further, the content retrieving program 30 can operate not only to access the URI (the Web page) designated by the circulating URI data, but also to access all Web pages of the Web site which includes the Web page and to retrieve each layout tree. Further, the content retrieving program 30 can operate to extract links included in the Web page from the layout tree, based, for example, on a predetermined tag (for example, href) or a specific text contained in the Web page, and to access the linked Web pages and to retrieve each layout tree.

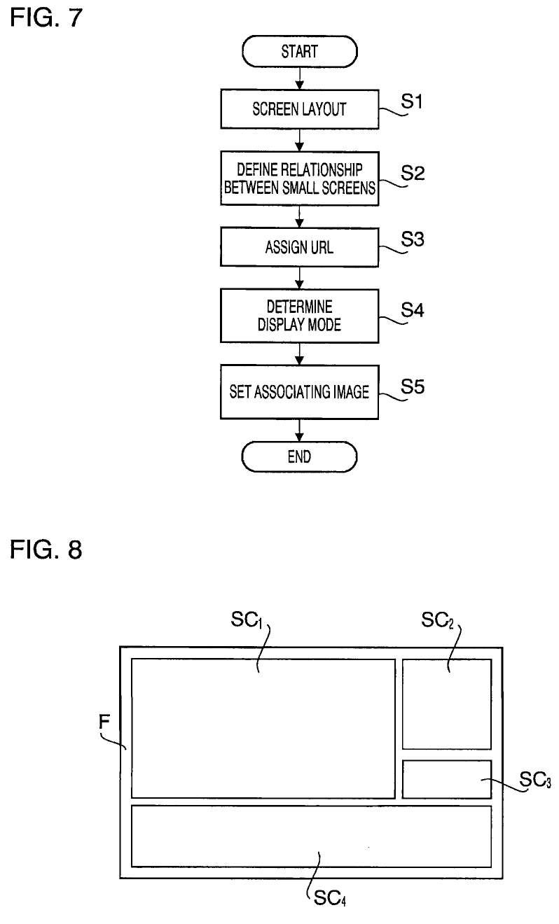

Next, the CPU 103 executes the moving image generating program 40. Here, in FIG. 7, the flow chart of the generating structure information determination process executed by the moving image generating program 40 is shown. The generating structure information determination process shown in FIG. 7 is a process for defining a mode for generating a moving image (for example, a layout of contents and moving images consisting the moving image, and a moving image pattern, etc.). Through the generating structure information determination process, the moving image with the layout, for example, shown in FIG. 8 is generated.

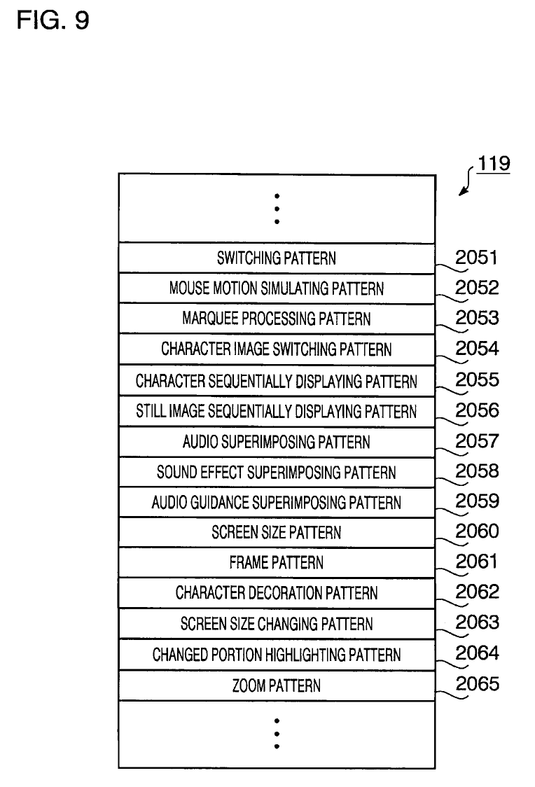

Further, in the generating structure information determination process shown in FIG. 7, the moving image pattern of the contents forming the moving image is designated. Here, in FIG. 9, the effect process pattern data stored in the HDD 119 is shown. The effect process pattern data are data for adding the effects to the contents. The moving image pattern of the content is defined, for example, by the effect process pattern data.

As it is shown in FIG. 9, the effect process pattern data includes, for example, a switching pattern 2051, a mouse motion simulating pattern 2052, a marquee processing pattern 2053, a character image switching pattern 2054, a character sequentially displaying pattern 2055, a still image sequentially displaying pattern 2056, an audio superimposing pattern 2057, a sound effect superimposing pattern 2058, an audio guidance superimposing pattern 2059, a screen size pattern 2060, a frame pattern 2061, a character decoration pattern 2062, a screen size changing pattern 2063, a changed portion highlighting pattern 2064. Further, the effect process pattern data described here is an example, and various other types of effect process pattern data are assumed.

Each effect pattern data is described below.

### The Switching Pattern 2051

Data of various types of effect patterns for switching, which are utilized for switching contents in the moving image generated in the moving image generating process.

### The Mouse Motion Simulating Pattern 2052

Data of a pattern of a pointer image, which is combined with the moving image generated in the moving image generating process and displayed, and data of various motion patterns, etc., of the pointer image.

### The Marquee Processing Pattern 2053

Data for marquee displaying texts, which are contained in a content in the moving image generated in the moving image generating process. Further, the marquee displaying means that displaying an object to be displayed (here, the texts) in such a way that the object moves on the screen as if it were flowing.

### The Character Image Switching Pattern 2054

Data of various types of effect patterns for switching, which are utilized for switching between texts and images in the moving image generated in the moving image generating process.

### The Character Sequentially Displaying Pattern 2055

Data of various displaying patterns for displaying a bundle of text, slowly from the top, in the moving image generated in the moving image generating process.

### The Still Image Sequentially Displaying Pattern 2056

Data for various displaying patterns for displaying a still image, slowly from one portion to the whole, in the moving image generated in the moving image generating process.

### The Audio Superimposing Pattern 2057

Data of various audio patterns which are synchronized with the moving image generated in the moving image generating process.

### The Sound Effect Superimposing Pattern 2058

Data of various sound effect patterns which are synchronized with the moving image generated in the moving image generating process.

### The Audio Guidance Superimposing Pattern 2059

Data of various audio guidance patterns which are synchronized with the moving image generated in the moving image generating process.

### The Screen Size Pattern 2060

Data for defining each size of the whole moving image generated. Such sizes include, for example, the size conforms to XGA (eXtended Graphics Array), or NTSC (National Television Standards Committee), etc.

### The Frame Pattern 2061

Data of various frame patterns separating small screens in the moving image. For example, as shown in FIG. 8, there is a frame F which separates small screens SC₁-SC₄.

### The Character Decoration Pattern 2062

Data of various types of decoration patterns, which are added to a text contained in a content.

### The Screen Size Changing Pattern 2063

Data for changing the screen size defined by the screen size pattern 2060, and the data corresponding to the screen size which has been changed.

### The Changed Portion Highlighting Pattern 2064

Data of various types of highlight patterns, which are combined with the whole or a portion of the content which has been changed, in the moving image generated in the moving image generating process.

### A Zoom Pattern 2065

Data of zoom effect patterns which are utilized for zooming in and out an image of a designated portion at a specified timing and with a specified speed, in the moving image generated in the moving image generating process.

According to the generating structure information determination process shown in FIG. 7, first, a screen layout is determined (step 1, hereinafter, step is abbreviated by “S” in the specification and in the figures). Specifically, in the layout processing of S1, data for defining the screen size and the frame pattern, designated by the scenario made by a third party 1071, is determined from the screen size pattern 2060 and the frame pattern 2061. Further, for the sake of simplicity of the explanation, it is assumed that by the generating structure information determination process executed in the embodiment, for example, the moving image shown in FIG. 8 is generated. Therefore, in the screen layout processing of S1, the frame F shown in FIG. 8 is selected as the frame pattern.

After the screen layout processing of S1, reference relationships, transition relationships, and interlock relationships, etc., among small screens are defined (S2). By the defining process of S2, for example, one of the neighboring two small screens (for example, the small screen SC₁) is defined to be the small screen for displaying a portion of a Web page, and the other one (for example, SC₂) is defined to be the small screen for displaying the whole Web page. The defining process of S2 is executed, for example, based on the scenario made by a third party 1071. Furthermore, the definition of each relationship can be uniquely determined at the point of selection of the frame pattern from the frame pattern 2061, for example, in the process of S1.

Following the defining process of S2, a Web page to be displayed on each small screen is determined (S3). Specifically, based on the scenario made by a third party 1071, for each small screen, a URI for one (or plural) Web page to be displayed is assigned. Further, the scenario made by a third party 1071 can be, for example, described so as to assign a URI by invoking the display mode rule 1059.

After the assigning process of S3, a display order of the Web page of each assigned URI, a time for displaying the moving image, a time for switching a display, and a moving image pattern, etc., are determined (S4). In this manner, a display mode of each Web page, namely, how to display each Web page, is determined.

In the display mode determining process of S4, for example, the case in which one URI is assigned to a small screen SC₁ is explained. In this case, for example, based on the scenario made by a third party 1071, a time for displaying moving image and a moving image pattern for one Web page are determined. The moving image patterns specified by the scenario made by a third party 1071 include, for example, effects by the mouse motion simulating pattern 2052, the marquee processing pattern 2053, the character image switching pattern 2054, the character sequentially displaying pattern 2055, the still image sequentially displaying pattern 2056, the audio superimposing pattern 2057, the sound effect superimposing pattern 2058, the audio guidance superimposing pattern 2059, and the effect by the character decoration pattern 2062.

Further, in the display mode determination process of S4, for example, the case in which plural URIs are assigned to a small screen SC₁ is explained. In this case, for example, based on the scenario made by a third party 1071, display orders, time for displaying moving image, times for switching displays, and moving image patterns for plural Web pages are determined. Further, the display orders can be, for example, in accordance with the circulating data 1055. The moving image patterns specified by the scenario made by a third party 1071 include, for example, effects by the switching pattern 2051, the mouse motion simulating pattern 2052, the marquee processing pattern 2053, the character image switching pattern 2054, the character sequentially displaying pattern 2055, the still image sequentially displaying pattern 2056, the audio superimposing pattern 2057, the sound effect superimposing pattern 2058, the audio guidance superimposing pattern 2059, the character decoration pattern 2062, and the changed portion highlighting pattern 2064.

Further, the scenario made by a third party 1071 can be described in such a way that, in the display mode determination process of S4, a display order, a time for displaying moving image, and a time for switching a display for a Web page are determined by invoking, for example, the display mode rule 1059. Further, in the display mode determination process of S4, it is not always necessary to apply a moving image pattern to each Web page. Further, when applying a moving image pattern, the number of the applied moving image patterns can be one, or more than one. For example, for one Web pate, two moving image patterns such as the marquee processing pattern 2053 and the character image switching pattern 2054 can be applied.

After the display mode determination process of S4, an associating image for each Web page is configured (S5). Specifically, based on the scenario made by a third party 1071, displaying patterns of a retrieval time and an elapsed time, a superimposing pattern, an audio interlocking pattern, which are to be associated and displayed with each Web page, are configured. Further, a retrieval time is a retrieval time of a content, which is associated with each layout tree stored in the area for layout trees in the RAM 107. Further, an elapsed time is information obtained by a result of a comparison between the current time and a retrieval time of a content by the RTC 121, it can be an index for a user to determine if information contained in a Web page is new or not.

When the associating image configuration process of S5 is executed, the generating structure information determination process in FIG. 7 is terminated, after that, the moving image generating process is executed.

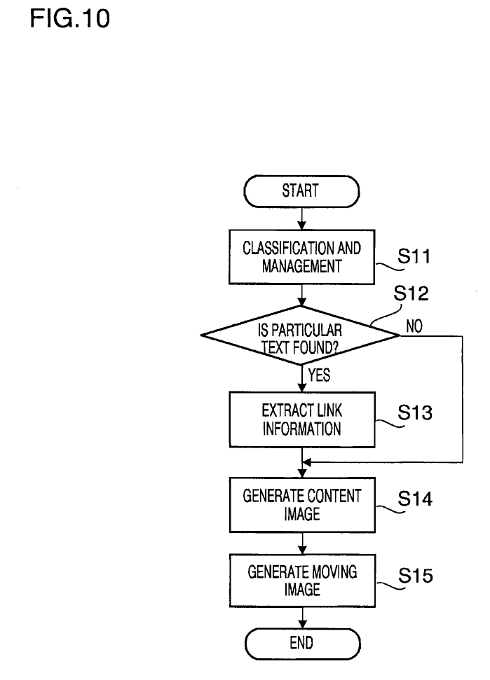

FIG. 10 is a flow chart of the moving image generating process executed by the moving image generating program 40.

According to the moving image generating process shown in FIG. 10, first, by referring to each layout tree which has been made, each Web page is classified into displaying pieces of information and unnecessary pieces of information (for example, images and texts, or specific elements and other elements) and managed (S11). Images, texts, or respective elements can be classified and managed, for example, based on tags. Further, the displaying pieces of the information and the unnecessary pieces of the information are determined by the scenario made by a third party 1071 (or the content extraction rule 1060), and their classifications and managements are executed. Further, displaying pieces of information are the pieces of the information to be displayed on a moving image to be generated, and unnecessary pieces of the information are the pieces of the information not to be displayed on the moving image. For example, if only texts have been classified as displaying pieces of information, then Web page images generated in the subsequent process are images only displaying texts, and for example, if only images have been classified as displaying pieces of information, then the Web page images are images only displaying respective images. Further, for example, if only specific elements (for example, class=“yjMT”, etc.) are classified as displaying pieces of information, then the Web page images generated in the subsequent process are images only displaying the elements (for example, news information, etc., flowed on a headline).

Following the classification and management process of S11, it is determined that whether the above displaying pieces of the information contains specific texts (or the corresponding portion of the HTML document contains a predetermined tag (for example, href)) or not. Further, as the specific texts, for example, there are “details,” “explicative,” “next page,” etc. If the specific texts are included (S12: YES), then it is determined that the texts are associated with link information, and the link information is extracted from the above displaying pieces of the information (S13). Then the extracted link information is passed to the content retrieving program 30 and the process proceeds to S14. Further, if the specific texts are not included (S12: NO), then the process proceeds to S14 without executing the extracting process of S13. Furthermore, after receiving the extracted link information, which is extracted in the process of S13, the content retrieving program 30 executes the same process as the process explained above, and operates to retrieve a layout tree of a linked target.

In the process of S14, rendering is performed based on displaying pieces of information of each layout tree stored in the area for layout trees in the RAM 107, and an image of a Web page (hereinafter, written as “content image”) is generated. By this, each Web page is processed to be in the display mode in which each Web page is corresponding to the assigned small screen. For example, suppose that the small screen SC₃ is defined to display texts only by the scenario made by a third party. In this case, for a layout tree of each URI which is assigned to the small screen SC₃, rendering for texts only is performed, and a content image is generated. Further, for example, suppose that the small screen SC₂ is defined to display specific elements only by the scenario made by a third party. In this case, for a layout tree of each URI which is assigned to the small screen SC₂, rendering for information about the specific elements (for example, news information, etc., flowed on a headline) only is performed, and a content image is generated. Namely, in the process of S14, a content image, which is made by, for example, extracting texts and other elements only from a Web page, is obtained. Further, each content image generated is stored, for example, in an area for content images in the RAM 107.

Following the content image generating process of S14, a moving image is generated (S15) and the moving image generating process of FIG. 10 is terminated. In the process of S15, each content image stored in the area for content images in the RAM 107 is sequentially read out based on the result of the display mode determining process of S4 of FIG. 7 (namely, based on the display order, time for displaying moving image, and times for switching display, etc.), and processed based on each effect process pattern data and the result of the associating image configuration process of S5. Next, based on the results of the defining process of S2 and the assigning process of S3 in FIG. 7, each processed image is combined with each small screen of the frame pattern image which is determined in the screen layout processing of S1 of FIG. 7. Next, each combined image is formed as a frame image which is conforming to, for example, the format of MPEG-4 (Moving Picture Experts Group phase 4) or NTSC, etc., and a single moving image file is generated. In this manner, a moving image, for example, in which contents displayed on each small screen are set to be dynamic by the effects and the contents displayed on each small screen are sequentially switched to different contents with respect to time, is completed.

The moving image generated by the moving image generating program 40 is distributed to each client through the network interface 109.

Here, a number of examples of effect process pattern data are described.

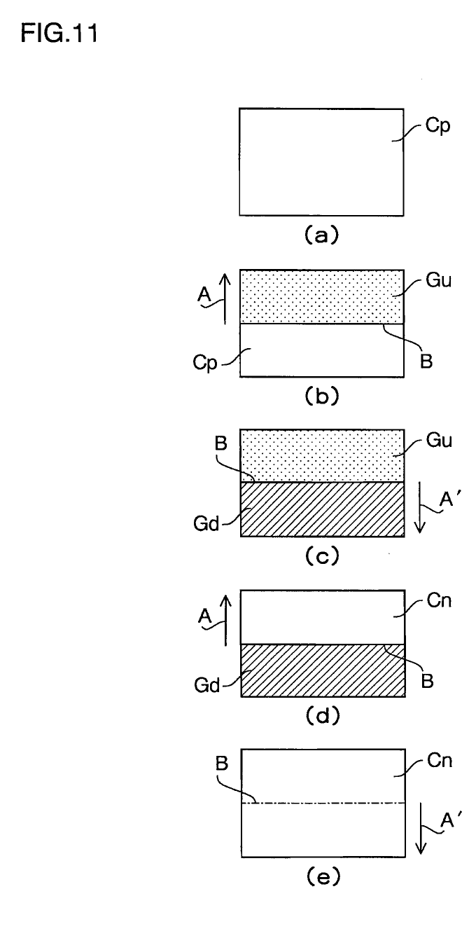

First, by referring to FIG. 11, one example of the switching pattern 2051 is explained.

FIG. 11 illustrates an example in which a content Cₚ is switched to a content Cₙ, by an effect pattern for switching which is utilizing switching images Gᵤ and G_{d}. When the effect pattern for switching of FIG. 11 is applied, in the process of S15, plural processed images, which are made by processing contents Cₚ and Cₙ, are generated so that the content is to be switched as described below.

FIG. 11(a) illustrates the state before the content is switched, namely the state in which the content Cₚ is displayed. When the switching process is started, in the regions, which are formed by horizontally dividing the screen (or the small screen) into two equal parts with a boundary B as the boundary, the switching images Gᵤ, and G_{d} are drawn, respectively, in turn (cf., FIG. 11(b), (c)). In particular, the switching image Gᵤ is gradually drawn, spending a predetermined time, from the boundary B in the upward direction on the screen (the direction of arrow A), and next, the switching image G_{d} is gradually drawn, spending a predetermined time, from the boundary B in the downward direction on the screen (the direction of arrow A′). In this manner, the state, in which the switching images Gᵤ and G_{d} are displayed on the screen, is realized. Next, the upper half and the lower half of the content Cₙ, are drawn in the regions, respectively, in turn (cf., FIG. 11(d), (e)). In particular, the upper half of the content Cₙ, is gradually drawn, spending a predetermined time, from the boundary B in the upward direction on the screen (the direction of arrow A), and next, the lower half of the content Cₙ, is gradually drawn, spending a predetermined time, from the boundary B in the downward direction on the screen (the direction of arrow A′). In this manner, the state, in which the content Cₙ, is displayed on the screen, is realized and the switching is completed. Further, the time for switching a display determined by the display mode determining process of S4 is the time which is spent for drawing the whole of the content Cₙ, which starts from the beginning of drawing the switching image Gᵤ. Further, each predetermined time for drawing the switching image Gᵤ, etc., depends on the time for switching a display, and determined by the time for switching a display.

Next, an example of the marquee processing pattern 2053 is described.

Parameters for the marquee processing pattern 2053 include, for example, a time interval in which the texts subjected to the marquee display (hereinafter, abbreviated as “marquee texts”) are displayed, a moving speed, etc. When the marquee processing pattern 2053 is applied, the concrete numerical values for the above parameters are determined, for example, by the scenario made by a third party 1071. Further, a repetition number of the marquee display is determined based on the above parameters, the number of characters of the marquee texts, and the maximum number of characters displayed on the small screen on which the marquee texts are displayed. Next, based on these decided matters, text images corresponding to respective frames, which are to be marquee displayed on the small screen during the time interval determined above, are generated. The generated text images are combined with the frame pattern images, which are corresponding to the frames, respectively. In this manner, a moving image including the texts to be marquee displayed is generated.

Next, an example of the character sequentially displaying pattern 2055 is described.

Parameters for the character sequentially displaying pattern 2055 include, for example, a reading and displaying speed, etc. When the character sequentially displaying pattern 2055 is applied, the concrete numerical values for the above parameters are determined, for example, by the scenario made by a third party 1071. Next, based on the above parameters, an area on which the target character string is to be displayed, and a size of characters, concealment curtain images to conceal characters are generated, corresponding to respective frames. After that, the generated concealment curtain images are combined with the frame pattern images, which are corresponding to the frames, respectively. In this manner, a moving image, in which characters are gradually displayed in accordance with, for example, a user's speed of reading characters, is generated.

Furthermore, as an example of effect process pattern data, the following can be considered.

For example, using the mouse motion simulating pattern 2052, it is possible to generate a moving image of a situation in which a part of a content is clicked and displayed. Such moving images include, for example, a moving image in which a mouse pointer is moved to a linked Web page and the link is selected, and a screen transition to the linked Web page is made.

Further, for example, by using the character image switching pattern 2054, it is possible to generate a moving image in which an image of contents including images and texts (for example, a Web page of a news item with images or a recipe of cooking, etc.) and texts are alternatively switched at every constant time interval.

Further, it is possible to generate a moving image in which no motion is added to contents themselves and only a transition effect for the time of switching contents is added (for example, a moving image consists of repetitions of a still image and a transition effect, etc.).

Further, for example, it is possible to generate a moving image with audio by synchronizing various types of audio patterns with corresponding frame images, using, for example, the audio superimposing pattern 2057, the sound effect superimposing pattern 2058, and the audio guidance superimposing pattern 2059, etc.

Further, the associating images of a retrieval time, or an elapsed time, etc., are generated corresponding to each frame, based on the setting of the associating image configuration process of S5 of FIG. 7, for example. Then, each generated associating image is combined with the frame pattern image corresponding to each frame. In this manner, for example, a moving image including an associating image is generated.

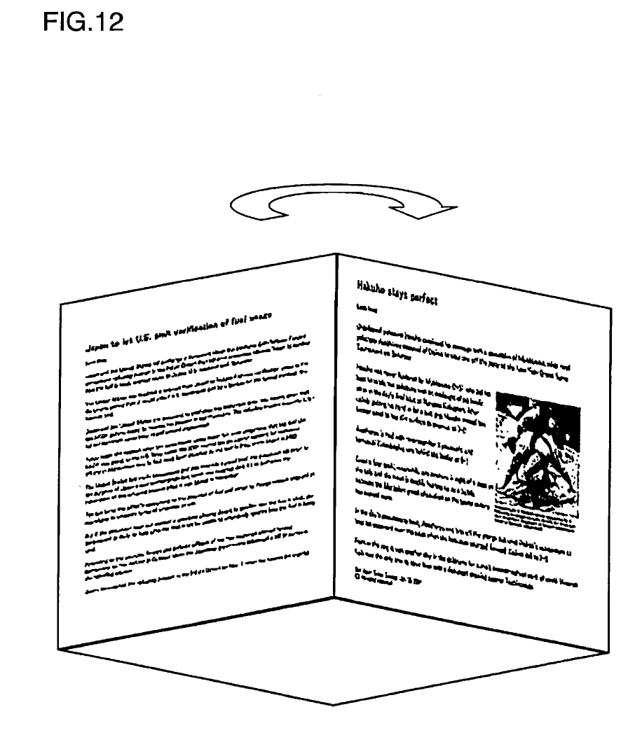

Further, the frame pattern 2061 in the above embodiment is a two-dimensional fixed pattern, but frame pattern configurations are not limited to the configuration of this type. For example, the frame pattern 2061 can provide a three-dimensional frame pattern, and also can provide a dynamic frame pattern (namely, a frame pattern which changes in a position, in a direction, and in a figure, as time goes on). FIG. 12 illustrates an example of a three-dimensional dynamic frame pattern provided by the frame pattern 2061. The frame pattern of FIG. 12 is an example of a frame pattern for which a small screen is provided for each side of a rotating cube. In the moving image generating process of S15, in accordance with the figure of each small screen which changes as the cube rotates, a content image of a Web page assigned to each small screen is deformed and combined with the frame pattern. For example, if a Web page of a different news article is assigned to each small screen, then the news articles can be read, in turn, as the cube rotates. Further, when a small screen is turned around and placed in the reverse side of the cube, the display of the small screen is switched to the next article. With this configuration, it is possible to read the whole articles, sequentially, by looking the rotation of the cube.

As another example of a dynamic frame pattern of this type, for example, a frame pattern with a figure which is similar to an onion skin can be considered. In this case, the frame pattern changes as if onion skins are peeling off in order, from the outermost skin, and in accordance with this, a Web page to be displayed is switched.

As explained above, the administrator of the moving image generating server Sₘ can generate various moving images by setting contents which are included in a moving image, a display order of each content and a displaying time of each content, and effects to be applied to each content, using the process pattern data, the process pattern updating data, and the effect process pattern data, and can provide them to clients. Since Web pages include Web pages which are periodically updated, once each parameter is set, it is possible to provide always a moving image including new information to clients.

For example, it is possible to generate, for each small screen of FIG. 9, a moving image including the information below.

### The Small Screen SC₁

A news screen is displayed. Specifically, plural pieces of headline information of news sites which are cyclically visited, one of the plural pieces of headline information, the detailed piece of information about the one of the plural pieces of headline information are alternatively displayed. When the detailed piece information is displayed, characters are sequentially changed in color from light blue to black, with a constant speed which is assumed to be the user's reading speed. In the case of a news item with images, the display is switched in the order, from images to characters.

### The Small Screen SC₂

Expressions of mails and my page are displayed. A piece of arrival information of a mail to an account, such as Yahoo mail (registered trademark), which has been registered by an end user in advance, and each Web page which is included in my page are switched and displayed, in this order, by effects. In the bottom part of the small screen, a counter, which shows which seconds later from now, the display is switched to the next Web page, and a retrieval time of the Web page, which is currently displayed, are displayed.

### The Small Screen SC₃

Economic information is displayed. Information about currency exchange such as the yen, the dollar, of foreign markets, etc., is displayed. In the bottom part of the small screen, a retrieval time of a Web page is displayed.

### The Small Screen SC₄

Information about weather and traffic is displayed. Weather of all over Japan, local regions (such as Kanto region), and narrower regions (city, town, village, etc.) is displayed in this order. Further, information about trains and roads in a neighboring area in which an end user lives is flowed from right to left by the marquee display.

Next, a client, to which a moving image is distributed from the moving image generating server Sₘ, is explained. These clients include, for example, home servers HS₁-HSₓ placed in the LAN₁-LANₓ, respectively.

First, the LAN₁-LANₓ are explained. Each one of the LAN₁-LANₓ is, for example, a network constructed in a home of each end user, and it includes a home server connected to the Internet, and plural terminal devices locally connected to the home server. Each of the LAN₁, LAN₂, . . . , LANₓ include the home server HS₁ and terminal devices t₁₁-t₁ₘ, the home server HS₂ and terminal devices t₂₁-t₂ₘ, . . . , the home server HSₓ and terminal devices tₓ₁-tₓₘ, respectively. Further, for the LAN₁-LANₓ, various types are assumed, for example, they can be wired LANs or wireless LANs.

The each of the home servers HS₁-HSₓ are, for example, widely known desktop PCs, and similarly to the Web server WS₁, they include CPUs, ROMs, RAMs, network interfaces, and HDDs, etc. Each home server is configured so that it can communicate with the moving image generating server Sₘ, through a network. Further, since the home servers HS₁-HSₓ have the similar configurations as the configuration of the Web server WS₁, figures of the home servers HS₁-HSₓ are omitted.

Further, each of the home servers HS₁-HSₓ are substantially the same with respect to essential components in the embodiment. Also, each of the terminal devices t₁₁-t₁ₘ, . . . , tₓ₁-tₓₘ are substantially the same with respect to essential components in the embodiment. Therefore, in order to avoid overlapping of explanations, the explanation of the home server HS₁ and the terminal device t₁₁ represents the explanations of the plural home servers HS₂-HSₓ and the terminal devices t₁₂-t₁ₘ, t₂₁-t₂ₘ, tₓ₁-tₓₘ.

The home server HS₁ in the embodiment conforms to the DLNA (Digital Living Network Alliance) guideline, and it operates as the DMS (Digital Media Server). Further, devices connected with the home server HS₁, such as the terminal device t₁₁, etc., are appliances conforming to the DLNA guideline, such as a TV (Television), etc. Furthermore, as these terminal devices, various types of products can be adopted. All devices which can reproduce moving images, for example, display devices with TV tuners, such as a TV, various devices which can reproduce streaming moving images, and various devices which can reproduce moving images, such as ipod (registered trademark), etc., are considered. Namely, a terminal device in each LAN is one of all the devices which can display a signal, which contains a moving image, in a predetermined format on their display screen.

When the home server HS₁ receives moving images from the moving image generating server Sₘ, the moving images are transmitted to each terminal device in the LANs, and reproduced in each terminal device. In this manner, an end user can enjoy “viewing while doing something else” information for bidirectional communications such as a Web content, using various terminal devices in home. Further the moving images to be distributed can be constructed with frame images in raster form, thus it is not necessary for each terminal devices to store font data. Therefore, an end user can browse, for example, characters of all the countries with each terminal device.

In the above embodiment, text information in a content, for example, is displayed in a moving image as the same text information even after the addition of an effect, such as a marquee effect, etc. However, information which can be intuitively grasped such as a figure or audio is more suitable for “viewing while doing something else” than texts. In a second embodiment of the present invention explained next, moving images are generated using information which is made by converting elements extracted from a content (texts, for example) into a different type of information (figures or audios, for example). By converting, in this manner, types of elements included in a content, it is possible to generate moving images which are more suitable for “viewing while doing something else.”

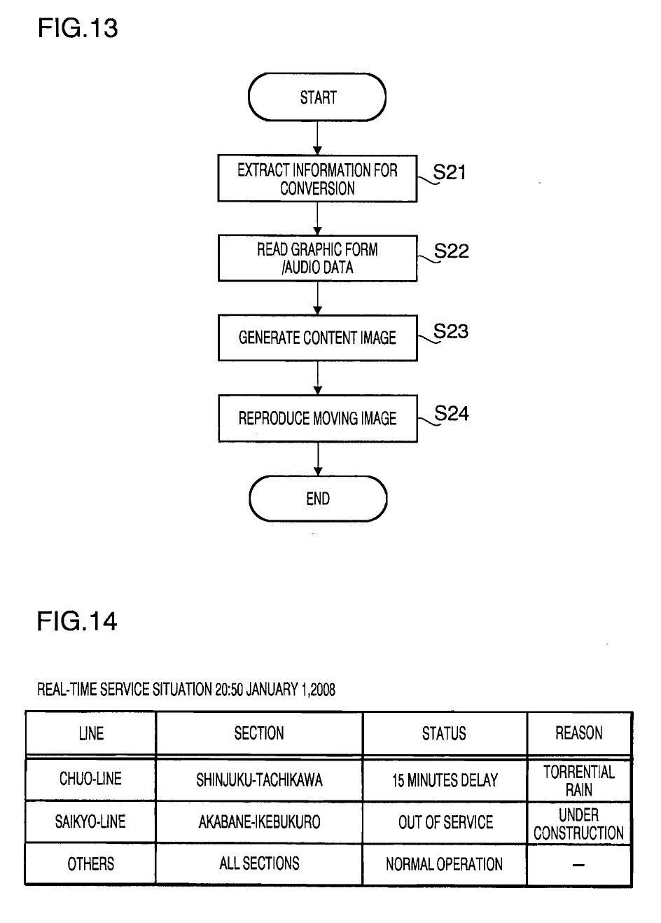

FIG. 13 illustrates a flow chart explaining the moving image generating process in the second embodiment of the present invention. The moving image generating process in the second embodiment is executed in accordance with the flow chart of FIG. 13, instead of the flow chart of FIG. 10. Further, each step of the moving image generating process is executed in accordance with the scenario made by a third party (or the content extraction rule 1060).

Majority of Web sites of transportation facilities, such as railway companies, are providing Web pages in which real-time service situations are displayed, as shown, for example, in FIG. 14. If a predetermined Web page, which provides such real-time information, is retrieved, then in the moving image generating process of FIG. 13, first, the layout tree made from the Web page is referred to, and a text portion which should be converted (hereinafter, referred to as “text to be converted”) into figure information (including information about color) or audio information is extracted from the Web page as specific element (S21). In the case of an Web page shown in FIG. 14, an information update time (22:50) and each text in the table are corresponding to the texts to be converted. Next, the meaning of each text to be converted is analyzed (S22).

Incidentally, for each predetermined Web page, expression information (hereinafter, referred to as “basic graphic/audio data”) is prepared, in advance, in the HDD 119 of the moving image generating server Sₘ. The conversion into text information, etc., is performed by properly selecting and processing the basic graphic/audio data, based on the result of analysis of the text to be converted in S22.

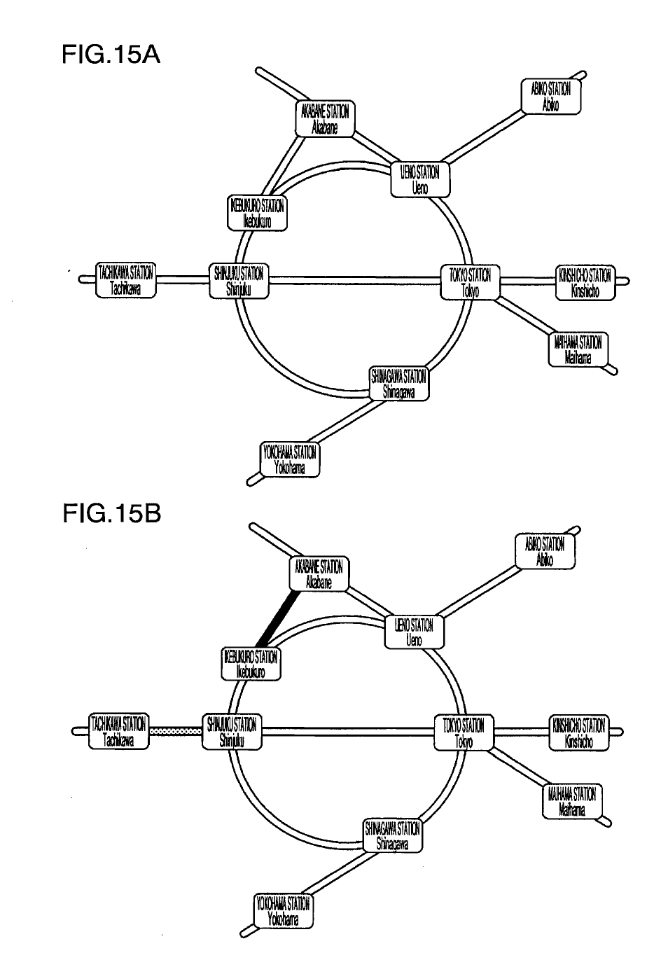

After the text analysis in S22, a route map (FIG. 15A) is read in from the HDD 119 (S23) as the basic graphic/audio data corresponding to the Web page of FIG. 14. Then, based on the result of the analysis in S22, the graphic data illustrated in FIG. 15B, which is the graphic data based on the route map of FIG. 15A in which colors representing service information of respective sections are added, is made. Specifically, the bar connecting Shinjyuku and Tachikawa is filled with the yellow color, for example, which represents “delay,” and the bar connecting Ikebukuro and Akabane is filled with the red color, for example, which represents “cancellation.” Since, in the other sections, it is normally operated, bars representing each of the other sections are not filled with any color. And, based on the developed graphic data, rendering is performed, and a content is developed (S24).

Following the content image generating process of S24, a moving image is generated (S25). The moving image generating process of S25 is the same process as the moving image generating process of S15. Further, based on the result of analysis of the texts to be converted in S22, the effect process pattern data to be utilized (the audio superimposing pattern 2057, the sound effect superimposing pattern 2058, and the audio guidance superimposing pattern 2059, etc.) is determined. For example, in the case in which there exists cancellation or delay, an warning tone or an audio guidance, which represents them, is retrieved from the sound effect superimposing pattern 2058 or the audio guidance superimposing pattern 2059, and superimposed on the moving image.

As described above, conversion of elements included in a content can not only be applied to traffic information (service information of railways, airlines, buses, and ferryboats, etc., or information about traffic congestion or traffic regulation, etc.) but also can be applied to an Web page which provides other real-time information in terms of text data. The other real-time information includes, for example, weather information, information about congestion of a restaurant, an amusement facility, or a hospital (an waiting time, etc.), information about rental housing, real estate sales information, and value of stock. For example, the moving image generating server Sₘ extracts text data concerning probability of rain, temperature, and wind speed of each region from an Web page which provides weather information, reads in the basic graphic/audio data, such as map data, etc., corresponding to the Web page stored in the HDD 119, etc., in advance, and, for example, can fill each region on the map with the color corresponding to the numerical value of the probability of rain of the region.

Further, besides the above described method of filling the region corresponding to each text data with the color corresponding to the value of the text data, various other methods can be utilized to convert text information into graphic information or audio information. For example, a pictorial diagram corresponding to the value of the text data (for example, graphics, etc., representing rainy weather, or road construction) can be overlapped in the position corresponding to each text data, such as map data, and displayed. Further, numerical values of, for example, rainfall levels or waiting times can be graphically represented by a bar chart, etc.

Further, for text data indicating a numerical value or a degree, a moving image, in which the numerical value, etc., is expressed in terms of the speed of time change of the pictorial diagram, can be generated. For example, congestion of a road can be expressed in terms of an arrow moving with the speed corresponding to the time required to pass each section, or an eddy rotating with the speed corresponding to the time required. Further, in the case, such as weather information, in which time-series data is provided, data for each time can be represented in a single frame image, and a moving image is generated by connecting these frame images based on the time of each data.

Further, in addition to the above conversion of text information into graphic information, audio information corresponding to the text information can be superimposed to generate moving images. For example, if the text information is weather information, a sound effect (sound of falling rain, etc.) corresponding to the weather indicated by the text information or BGM with a melody which fits with the weather can be played. Furthermore, if the text information is information about a numerical value or a degree, such as rainfall levels, then the tempo of the sound effect or the music can be adjusted in accordance with the numerical value which is indicated by the text information.

Further, the above conversion of text data can be performed not only by the moving image generating server Sₘ, but also the home servers HS₁-HSₓ, or terminal devices t₁₂-t₁ₘ, t₂₁-t₂ₘ,. . . , tₓ₁-tₓₘ. In this case, the home server or the terminal device can store the basic graphic/audio data in advance, and the moving image generating server can have a configuration in which the moving image generating server indicates what kind of conversion is to be performed by sending ID information to identify the basic graphic/audio data to be used to the home server.

Further, a modified example of the second embodiment as follows can be considered. When the moving image generating server Sₘ accesses the designated URI and there is no content corresponding to the designated URI, an error message, “404 Not Found,” is returned from the Web server. Many end users feel uncomfortable if such an unfriendly error message is shown. Thus, when such an error message is received, the moving image generating server Sₘ determines that it is a specific Web page and generates a moving image by using an alternative content corresponding to an error message, which has been prepared, in advance, in the HDD 119, etc. When the user sees the alternative content, the user can understand that there is no content in the URI without feeling uncomfortable. Furthermore, the moving image generating server S according to another modified example can operate so as to skip the URI and access the next URI, without using the alternative content.

Further, in the moving image distributing system according to a third embodiment, which is explained in the following, the moving image generating server Sₘ can generate and distribute an interactive moving image. Further, the interactive moving image, here, is a moving image which can realize a control corresponding to a selection of a predetermined position on the moving image when the predetermined position on the moving image is selected by a user operation. With the interactive moving image according to the third embodiment, an end user can view information of an Web content while doing something else, and if it is necessary, it is possible to add dynamically changes to the moving image by a user operation. Hereinafter, generation and operation of the moving image with interactivity are explained.

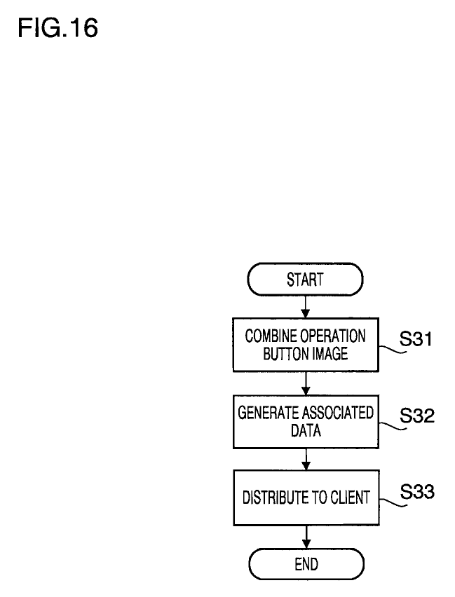

FIG. 16 is a flow chart illustrating an interactive moving image generating process to generate an interactive moving image. The interactive moving image generating process of the third embodiment is executed, for example, by the moving image generating program 40 (or another independent program).

According to the interactive moving image generating process illustrated in FIG. 16, first, an operation button image is combined with each frame image included in the moving image generated in the moving image generating process of FIG. 10. The operation button image, here, is a circular image of a radius of r pixels with characters such as “go back,” “end,” “stop,” “go back to 30 seconds before,” “move ahead to 30 seconds later,” “screen partition,” “layout switch,” “scrolling,” “zoom,” “change of screen,” and “display the linked target,” and, for example, it is stored in the area for operation button images in the HDD 119.

In the combining process of S31, for example, with the scenario made by a third party 1071, it is possible to set operation items to be executed on the moving image (namely, types of operation buttons to be combined with the moving image). And, it is possible to set a time interval, in which the operation items are set to be executable, contained in a time period in which the moving image is reproduced (namely, the time interval in which the selected operation button images are to be displayed), and display areas of the operation items on the moving image (namely, the positions where the operation button images are to be displayed). As an example, suppose that the administrator of the moving image generating server Sₘ has made a scenario made by a third party 1071, in which “end” has been set as an operation item, a time period of ten minutes, after the moving image has been started, has been set as its executable time period, and the pixel coordinate (X₁, Y₁) has been set as its displaying position, further, “end” and “go back” have been set as operation items, a time period of next 10 minutes has been set as their executable time period, and the pixel coordinates (X₁, Y₁) and (X₂, Y₂) have been set as their displaying positions. In this case, the operation button image of “end” is combined with each frame image included in the moving image of the ten minutes after the start, at the pixel coordinate (X₁, Y₁), and the operation button images of “end” and “go back” are combined with each frame image included in the moving image of the next ten minutes, at the pixel coordinates (X₁, Y₁) and (X₂, Y₂). As a result of this, the moving image after combining (hereinafter, referred to as “a moving image with an operation button”) is FIG. 17(a), for example, for ten minutes after it has been started, and FIG. 17(c), for example, for next ten minutes. Further, in the case in which there is no setting by the scenario made by a third party, for example, a predetermined operation button image can be combined with each frame image at a predetermined position.

Further, with the combining process of S31, data associating each frame image with the types of operation button images and their pixel coordinates, which have been combined with each frame image, (hereinafter, referred to as “associating data”) is formed (S32). The associating data is generated as a script, for example. Here, for each frame image included in the moving image, as it is known, a serial frame number (for example, frame numbers 1, 2, . . . , n, etc.) is assigned. Therefore, in the data forming process in S32, the associating data, which associates each frame number with the types of operation button images and the pixel coordinates, which have been combined with the frame image corresponding to the frame number, is formed. To explain using the example of FIG. 17, the associating data corresponding to the frame image of the first frame, for example, is the data associating frame number of 1 with the operation button image of “end,” and the pixel coordinate (X₁, Y₁).

After the associating data is formed in the data forming process of S32, the moving image with the operation button and the associating data are distributed to each client through the network interface 109 (S23).

When the home server HS₁ receives the moving image with the operation button and the associating data, the home server HS₁ stores them in a storing medium, such as an HDD, for example. Next, the home server HS₁ distributes the moving image with the operation button to each terminal device in the LAN₁. Additionally, the home server HS₁ sequentially reads out each frame image of the moving image with the operation button and expands it in a frame memory (not shown), and outputs it based on a predetermined frequency. Therefore, the frame images are sequentially input to each terminal device, and the moving image with the operation buttons is displayed on its screen.

Here, in order for an end user to operate dynamically the moving image with operation button, it is necessary that the home server and the terminal device are the corresponding devices for dynamic operations. In the ROM of the home server HS₁, a program for scanning moving image is stored, and the program is in a state that it is expanded and resides in the RAM. Further, in the case in which, for example, the terminal device t₁₁ is a TV, an application, etc., for a pointing device has been implemented to the TV, thus it is possible to click an arbitrary position on the screen of the TV with a remote controller.

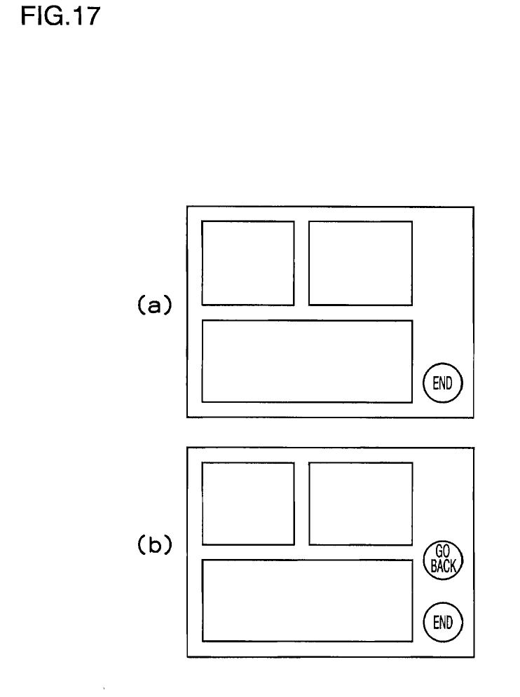

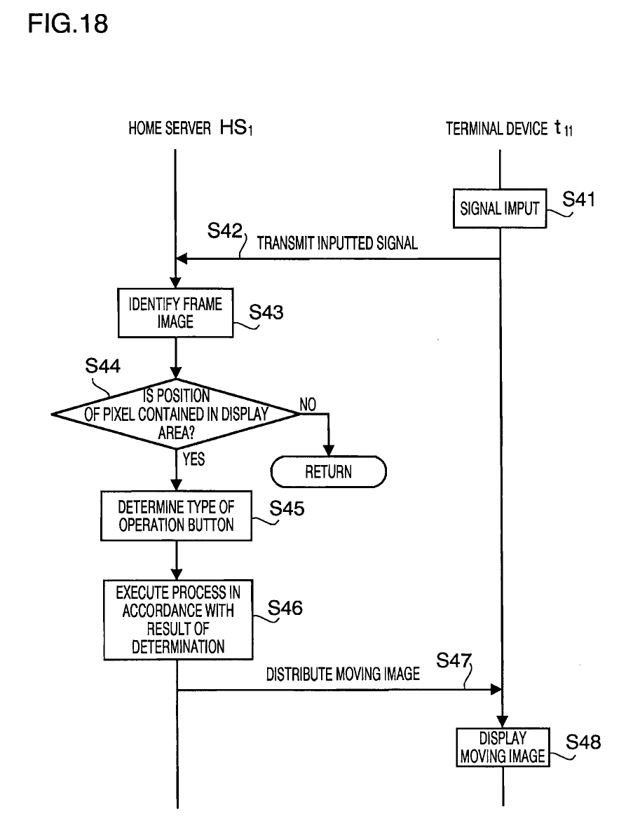

Hereinafter, a moving image operating process of FIG. 18 is explained. FIG. 18 illustrates a flow chart of the moving image operating process executed between the home server HS₁ and the terminal device t₁₁, when an end user operates the moving image. Further, the end user, here, is viewing the moving image illustrated in FIG. 17(b) using the terminal device t₁₁. This moving image operating process is executed if, for example, the end user operates the remote controller of the terminal device t₁₁ and clicks an arbitrary position on the screen.

According to FIG. 18, first, a signal corresponding to the click is input to the terminal device t₁₁ (S41). The terminal device t₁₁ sends this input signal to the home server HS₁ (S42). Further, the input signal includes the identifying information of the frame image (namely, the frame number), which was displayed when the click was made, and the pixel coordinate information of the click position.

After receiving the above input signal, the home server HS₁ identifies the frame image, which was clicked on the terminal device side, based on the frame number included in the input signal (S43).

Following the frame image identifying process of S43, by comparing the display areas of the operation button images in the identified frame image and the pixel coordinate information included in the input signal, it is determined that whether the position of the pixel coordinate is contained in the display areas or not. Further, the display areas, here, are the areas inside of the circles of radiuses r pixels each with their centers at the pixel coordinates (X₁, Y₁) and (X₂, Y₂), respectively. The home server HS₁ has been calculated the display areas, in advance, using the pixel coordinate (X₁, Y₁) and the radius r pixels, and the pixel coordinate (X₂, Y₂) and the radius r pixels.

In the determining process of S44, if it is determined that the above position of the pixel coordinate is not contained in the above display areas (S44: NO), then the home server HS₁ terminates the process without executing any process (or transmits a response to notify of the termination (an error signal, for example) to the terminal device t₁₁).

Further, in the determining process of S44, if it is determined that the above position of the pixel coordinate is contained in the above display areas (S44: YES), then the home server HS₁ determines the type of the operation button corresponding to the above display areas (S45). For example, if the above position of the pixel coordinate is placed inside of the area surrounded by the circle of radius r pixels with its center at the pixel coordinate (X₁, Y₁), then it is determined that the type of the operation button is “end.” Further, for example, if the above position of the pixel coordinate is placed inside of the area surrounded by the circle of radius r pixels with its center at the pixel coordinate (X₂, Y₂), then it is determined that the type of the operation button is “go back.”

Following the determining process of S45, the home server HS₁ executes the process corresponding to the result of the determination (S46). For example, if the result of the determination is “go back,” then the home server HS₁ sequentially reads out, again, the moving image with the operation button, which is currently distributed, from the top frame image, and expands it in the frame memory and outputs it (S47). In this manner, the moving image is reproduced from the beginning in the terminal device t₁₁ (S48).

Further, if the result of the determination is “end,” then the distribution of the moving image with the operation button, which is currently distributed, is terminated, and alternative to this, for example, a predetermined menu screen is distributed. Specifically, the image to be expanded in the frame memory is switched to the image of the predetermined menu screen, and the switched image is output. In this manner, the menu screen is displayed on the terminal device t₁₁.

Further, the menu screen can be constructed as a moving image with the operation button. The menu screen is constructed, for example, as a moving image on which a predetermined scene of each moving image is placed on the center of the screen in a thumbnail form and each operation button image (for example, a moving image button to determine a moving image to be reproduced or a button for a user setting, etc.) is placed in the surrounding part of the screen in a line. When the end user selects, for example, the intended moving image button on the menu screen, the same processes as the processes of S41-S45 are executed. Next, in the process of S46, the home server HS₁ sequentially reads out the moving image corresponding to the selected moving image button from the top frame image, and expands it in the frame memory and outputs it. In this manner, the moving image is reproduced in the terminal device t₁₁.

Further, for example, if the clicked image is “stop,” then in the process of S46, the home server HS₁ holds the frame image expanded in the frame memory (keeps holding one frame image) and outputs it. In this manner, the same frame image is continuously displayed in the terminal device t₁₁, namely the moving image is displayed with the state in which the moving image is stopped.

Further, for example, if the clicked image is “go back to 30 seconds before” (or “move ahead to 30 seconds later”), then in the process of S46, the home server HS₁ changes the frame image to be read out to the frame image with the frame number corresponding to the number formed by adding (or subtracting) a predetermined value to the frame number of the frame image which was clicked. And, after that, frame images are sequentially read out from the changed frame image, and expanded in the frame memory and output. In this manner, the moving image is reproduced from the position corresponding to the moving image which is rewound for 30 minutes (or forwarded for 30 minutes) in the terminal device t₁₁.

Further, if clicked image is “screen partition,” etc., then in the process of S46, by using single or plural frame images, the home server HS₁ sequentially generates, for example, frame images, which are divided into plural screens. Next, the generated frame images are sequentially read out, expanded in the frame memory and output. Further, in the cases of “layout switch,” “scrolling,” “change of screen,” etc., frame images are sequentially processed by applying predetermined image processes. Next, the processed frame images are sequentially read out, and expanded in the frame memory and output. In this manner, the moving image, in which changes such as a screen partition, a layout change, a scrolling, and a change of screen, etc., are added, is reproduced on the terminal device t₁₁.

Further, for example, if the Web content, which is the basis of the moving image and included in the moving image, includes link information, then the moving image generating program 40 extracts the link information, and the moving image generating program 40 can also utilizes the extracted link information to execute the data generating process of S32 of FIG. 16. Namely, in this case, the associating data generated in the process of S32 is the data mutually associating the frame numbers, the operation button images, the pixel coordinates, and the link information. In the case in which, for example, the clicked image on the moving image corresponding to such associating data is “display the linked target,” in the process of S46, the home server HS₁ refers to the associating data corresponding to the frame image, which was clicked, and retrieves the link information. Next, the home server HS₁ sends a request for page retrieving to the linked target (for example, the Web server WS₁). After receiving a response (a Web page) from the Web server WS₁, the home server HS₁ analyzes the response and generates drawing data, and sends the drawing data to the terminal device t₁₁. In this manner, the display on the terminal device t₁₁ switches from the moving image to the Web page of the Web server WS₁.

Next, some modified examples of the operation button of the third embodiment are explained. FIG. 19A is a figure illustrating a frame image of an interactive moving image with an operation button of a first modified example. The frame image of the first modified example includes, for example, a screen SC, on which each frame image included in the moving image generated in the moving image generating process of FIG. 10 is arranged, and trapezoidal frame buttons FB1-FB4, which are arranged along the four sides of the screen SC. The operation button of the first modified example differs greatly with the circular operation button in that the button is displayed even if the button is invalid. As in the above described circular operation button, a generating process of an interactive moving image and an operational process of a moving image are executed in accordance with the flow chart of FIG. 16 or the flow chart of FIG. 18.

For example, the frame button FB1 of the upper side is associated with the operation item “display the linked target,” the frame button FB2 of the right side is associated with the operation item “move ahead,” the frame button FB4 is associated with the operation item “go back,” and the frame button FB3 is associated with the operation item “stop,” respectively. These associations between the buttons and the operation items can be set, for example, by the scenario made by a third party or by user operations, etc.

First, the case, in which a frame image of an interactive moving image is generated from a frame image of a moving image which has no linked target, is explained. For example, a blue operation button image is selected for the frame button FB2 which is associated with the operation item “move ahead,” a green operation button image is selected for the frame button FB2 which is associated with the operation item “go back,” and an yellow operation button image is selected for the frame button FB3 which is associated with the operation item “stop,” respectively. In this case, since no linked target is associated with the frame of the moving image, the operation of “display the linked target,” which is associated with the frame button FB1 of the upper side, is invalid. Therefore, an operation button image with colorless color (gray, for example) is selected for the frame button FB1. Then, the frame image and each selected operation button image are combined, and the frame image of the interactive moving image of FIG. 19A is generated.

Next, the case, in which a frame image of an interactive moving image is generated from a frame image of a moving image with link targets, is explained. In this case, the operation item “display the linked target,” which is associated with the frame button FB1 of the upper side, is valid. Thus, an operation button image with a colorful color (red, for example) is selected for the frame button FB1. For the other frame buttons, FB2-FB4, the operation button images with the same colors, as in the case of the above frame image which has no linked target, are selected. Then, the frame image and each selected operation button image are combined, and the frame image of the interactive moving image of FIG. 19A is generated.

If a frame image of an interactive moving image is constructed in this manner, then it can be easily determined visually whether an operation button is currently valid or not, based on whether the operation button image is colorful on not. Besides colorfulness, the determination of the validity of the operation button can be made by using brightness, color phases, or patterns (including, for example, graphics or characters combined with the operation button image). In other words, the operation button of the first modified example is always displayed, including the case in which operations on the button are invalid, and in this case the button is displayed in a manner in which it can be recognized that operations on the button are invalid. Hence, the position of the operation button can be recognized in advance, and it follows that when the operations on the button become valid, the button can be immediately operated, easily. Further, since there is no change in the display, which is unusual and unpleasant to the eye, such as in a case in which the operation button suddenly appears or disappears on the display, the end user can enjoy watching the video without distraction. Further, since there are the operation button and the screen SC and there is no other redundant space, the display area is efficiently utilized.

FIG. 19B is a figure illustrating a frame image of an interactive moving image with operation buttons of a second modified example. In the second modified example, clickable areas (hereinafter, referred to as “display buttons”) DB1-DB4 are provided on the screen SC. The construction is the same as in the case of the first embodiment, except for the display buttons DB1-DB4. The display buttons DB1-DB4 have the shapes of the isosceles triangles which are formed by dividing the screen SC into four pieces with its diagonal lines. The display buttons DB1-DB4 themselves have no visibility, and the screen display is the same as in the case of the first modified example. When the display buttons DB1-DB4 are clicked, the same effects, as in the case in which the neighboring frame buttons FB1-FB4 are clicked, arise, respectively. Namely, in the first modified example, the image displaying positions of FB1-FB4 coincide with the response areas for a click. In the second modified example, only the response areas extend to the areas DB1-DB4 on the screen SC. In such a construction, as a result of the increase of clickable areas, a rough click operation can be accepted, and thus a user is not required to operate the buttons carefully so as to accurately click inside of the narrow display areas of the frame buttons FB1-FB4. Further, in the second embodiment which is illustrated in FIG. 19B, gaps (namely, areas on which no click can be made) are provided on the boundary areas of each of the display buttons DB1-DB4. By providing these areas on which no click can be made, errors in determining rough click operations can be reduced.

In the above embodiments and their modified examples, it is explained that the button operations are controlled by the operations of the pointing devices. However, the button operations can be controlled by key inputs using directional keys of up, down, left, and right, which are arranged on a remote button, etc., or by key inputs using color keys corresponding to the colors of the frame buttons FB1-FB4, or by touch panel inputs. Further, it is possible that a user can set to switch between the first modified example and the second modified example. Further, it is possible that, in the second modified example, a user can set whether there exist areas on which no click can be made or not.

Next, a moving image generating method according to a fourth embodiment of the present invention is explained. In the moving image generating method according to the fourth embodiment, by using a scenario, visual and auditory effects are added to a frame image in the middle of a moving image, and the frame image, to which the effects are added, is associated with a link. According to the moving image generating method, it is possible to obtain a moving image such that when the moving image is clicked at the timing when these effects are added, the linked Web page can be accessed.

It has been possible in the past to assign a link to a moving image at an arbitrary timing, by using a script, for example, with the following description:<link at=15 sec clickable=“http:www.foo.bar.com”>. However, in order to assign the link at a timing when an effect is added to the moving image, complicated tasks of adjusting the timing for adding the effect to the moving image and the timing to assign the link have been required. The moving image generating method according to the fourth embodiment eliminates the use of such complicated tasks by using the scenario.

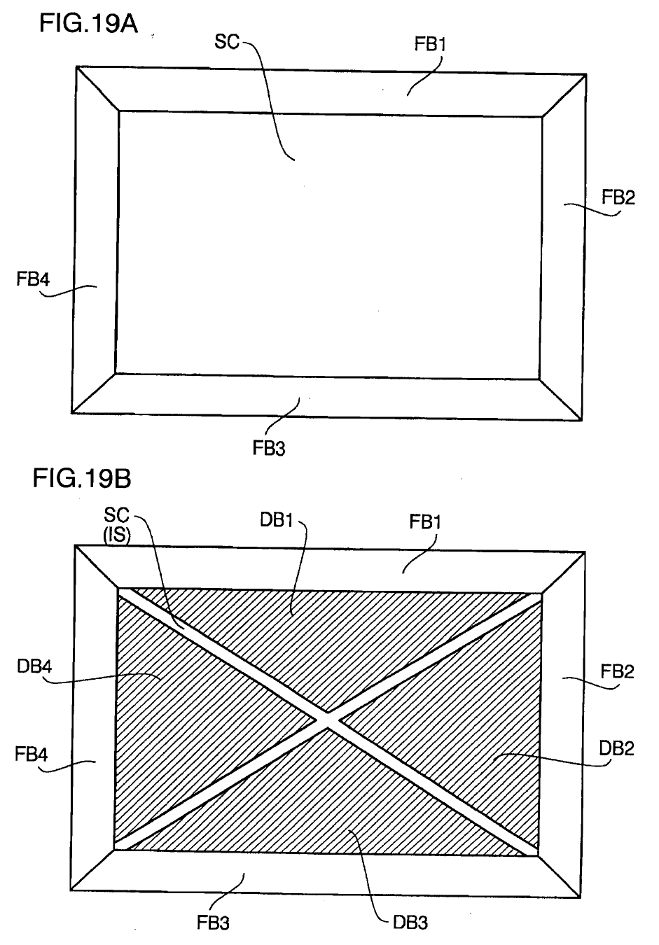

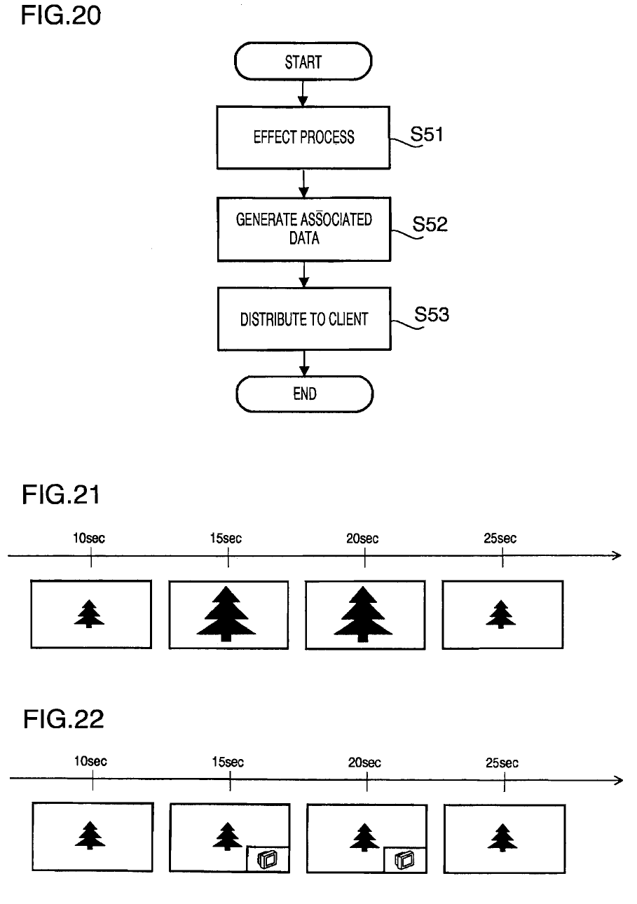

FIG. 20 illustrates a flow chart of the interactive moving image generating process according to the fourth embodiment of the invention. Further, FIG. 21 illustrates a figure of the screen transition for the case in which an effect of zoom is applied for 6 seconds, starting from 15 seconds after the start of the moving image, and a link is assigned to the frame image to which the effect is added, in accordance with the fourth embodiment of the invention.

According to the interactive moving image generating process illustrated in FIG. 20, first, a zooming process, as an effect process, is applied to a specified frame image, which is specified among the frame images included in the moving image generated in the moving image generating process of FIG. 10 (S51). The zooming process can be executed using a zoom pattern 2065. Matters such as the timing the zooming process is to be executed or the type of zooming process to be executed are set by the scenario made by a third party, for example. Following the effect process of S51, associating data, which associates each frame image with the effect process applied to the frame image, is formed (S52). In the associating data, each frame number is associated with the type of the effect process applied to the frame image (for example, a zooming process), the type (for example, zoom in or zoom out), and the number (numbers for identifying plural patterns of zoom in, which have different modes of representation, for example, in terms of zoom speed), for example.

Further, in the associating data forming process of S52, next, an associating process for associating the frame image, to which the effect is applied, with a link is executed. The associating process is executed, for example, with the following script: <link at=“zoomeffect:zoomin:m” clickable=http:www.foo.bar.com>. Here, “zoomeffect,” “zoomin,” and “m,” in the script, indicate the type of the effect process (the zooming process), the type (zoom in), and the number, respectively. In this manner, the associating process for associating the link information with the frame image, to which the effect process is applied, is executed.

When the associating data is formed at S52, the moving image, to which the zooming process is applied, and the associating data are distributed to each client through the network interface 109.

Further, in the above script, it is possible to write down an ID (for example, “A0288”) instead of the number m of the zoom effect. By separately writing down “A0288=1” to the header of the script, the number of the zoom in processing can be easily changed.

Further, in the above example, the link is associated with the frame image to which the effect process is applied. However, a link can be associated with frame images for a time period which has a predetermined relationship with the time period in which the effect process is applied to the moving image, for example, frames for a constant time interval before or after the frame images to which the effect process is applied. For example, when an effect is applied to the frame images with frame numbers from N₁ to N₂, it is possible to assign a link to the frame images with frame number from N₁−100 to N₁ (or from N₂ to N₂+100). These settings are established based on the scenario made by a third party 1071.

Further, the effect process that can be a subject of the interactive moving image generating process is not limited to the zooming process, and various other effect processes can be applied. FIG. 22 illustrates a figure of the screen transition for the case in which an effect of screen separation is applied and a link is added to one of the separated screens for 6 seconds, starting from 15 seconds after the start of the moving image.

The effect process of separating the frame image can be executed by combining plural content images, based on the frame pattern 2061 and the scenario made by a third party 1071. However, the effect process of separating the frame image can be prepared as a dedicated effect pattern. Here, the case in which there exists an effect pattern to perform frame image separation is explained.

In this case, also, the interactive moving image generating process is executed in accordance with the flow chart of FIG. 20. In the associating data formed in S52, each frame number is associated with a type of an effect process which is applied to the frame image (frame image separation), a number of partition (for example, 2 screen separation), and pixel coordinates for each of the divided screens.

Further, in the associating data forming process of S52, an associating process for associating the divided screen with a link is executed. The associating process is executed, for example, with the following script: <link at=“screenpattern:m:n” clickable=http:www.foo.bar.com>. This script specifies to assign a link to n-th divided screen of m screen partition. In this manner, an associating process for associating the divided screen with a link is executed.

In addition, various other interactive moving image generating processes can be executed in accordance with the flow chart of FIG. 20. For example, it is possible to execute an interactive moving image generating process such that an effect to make the moving image bright for a predetermined time period of the moving image is applied, and a link is assigned to the moving image for the predetermined time period. In this case, in the associating data formed in S52, each frame number is associated with a type of the effect process (increase brightness) which is applied to the frame image. And, by writing down the following script: <link at=“bright:m” clickable=http:www.foo.bar.com>, for example, to the associating data, the frame images, to which the effect is added, are associated with the link information. Further, “bright” shows the effect to assign brightness above a certain level to the frame image, and “m” shows the number corresponding to the effect.

Further, in another example, it is possible that an effect to assign only a sound effect is applied for a predetermined time period of the moving image, and a link is assigned to the frame image only for a time period in which the sound changes (for example, the level of the sound increases above a certain level). In this case, in the associating data formed in S52, each frame number is associated with a type of the effect process (increase sound level). For example, by writing down the following script: <link at=“loudvoice:m” clickable=http:www.foo.bar.com>, to the associating data, the frame images, which are displayed for the time period when the sound effect is applied, are associated with the link information. Further, “loudvoice” shows the effect to increase the sound level above a certain level.

By the above described interactive moving image generating process, a link is assigned to the moving image, and the interactive moving image, in which a time period when the moving image is clickable can be easily recognized, is obtained.

The embodiments of the present invention are described above. However, the present invention is not limited to the embodiments, and various modifications may be made within the scope of the present invention. For example, in the above described third embodiment, the interactive moving image generating process illustrated in FIG. 16 is executed in the moving image generating server Sₘ's side, and the moving image operating process illustrated in FIG. 18 is executed in the client's side. However, in another embodiment, both the interactive moving image generating process and the moving image operating process can be executed in the client's side (namely, the home server HS₁ and each terminal device in the LAM). Furthermore, all of the interactive moving image generating process and the moving image operating process can be executed in the home server HS₁. In this case, an end user operates the home server HS₁ and generates a moving image with interactivity, and the end user can watch the moving image on the display of the home server HS₁ (not shown).

Further, it can be assumed that there are plural types of moving images to be distributed, and, for example, in the data forming process of S32 of FIG. 16, a moving image ID for identifying each moving image can be added to the associating data. In this case, the input signal, which is sent in the process of S42 of FIG. 18, includes the moving image ID of the moving image which was clicked, in addition to the frame number and the pixel coordinate. The home server HS₁ refers to the moving image ID in the input signal and identifies the moving image which was clicked, after that, the processes S43-S47 of FIG. 18 are executed.

Further, in the above described third embodiment, it is possible to select an arbitrary position on the screen and click the position by using the remote controller. However, in another embodiment, only a predetermined position on the screen (for example, the displaying area of the operation button image) can be selected and clicked. In this case, for example, the process of S44 can be omitted.

Further, in the above described third embodiment, the frame number is adopted to identify the frame image of the time of the click. However, in another embodiment, the time can be adopted for identifying the frame image. In this case, for example, serial reproduction time information is associated with each frame image. For example, if reproduction of the moving image has been started exactly at 16:30 and the moving image is clicked at 16:38:24, then the frame image associated with the reproduction time of “8 minutes 24 seconds” is identified as the clicked image.

Further, in the above described third embodiment, the operation button image is a circle of radius r pixels. However, in another embodiment, various shapes and sizes can be assumed. As the shapes, for example, rectangles, triangles, or other polygons can be assumed.

Further, in the above described third embodiment, the moving image is constructed in such a way that the moving image operating process of FIG. 18 is executed when the operation button image is clicked. However, in another embodiment, the moving image can be constructed in such a way that the moving image operating process is executed when an arbitrary position on the screen is clicked.

As an embodiment, for example, a method of applying the operation button function to the whole screen can be considered. Specifically, alternative to the combining process of S31 of FIG. 16, operation items performed on the moving image and a time period when the operation items can be executed are set. Next, in the data forming process of S32, data, which associates each frame image corresponding to the above setting period with the operation items which has been set, is formed. Then, the formed data and the moving image are transmitted to the home server HS₁ as a set. Here, it is assumed, for example, that the operation item “go back” is associated with the last several seconds of the moving image (namely, each frame image corresponding to the last several seconds).

For example, if an end user clicks an arbitrary position on the screen just before the end of the moving image, then alternative to the S42 of FIG. 18, only the frame number is sent to the home server HS₁. Next, alternative to the processes of S43-45, the home server HS₁ refers to the above formed data and retrieves the operation item which is associated with the frame number (namely, “go back”). Then, the home server HS₁ sequentially reads out the moving image, again, from the top frame image and expands it in a frame memory and outputs it. In this manner, the end user can watch the moving image from the beginning.

Further, in another embodiment, operable matters are not limited by the display mode of the moving image. For example, electronic commerce can be executed on the moving image. In this case, the home server HS₁ receives a moving image which has been generated based on, for example, a predetermined site. In order to receive such a moving image, for example, a user authentication is required. On the moving image, for example, the operation button image with “shopping” is displayed along with the commercial products. If an end user clicks “shopping,” then the same processes as the processes of S41-45 are executed. Next, in the process of S46, the home server HS₁ sends out a request to order the above commercial products to the site. After that, a known communication process is executed between the home server HS₁ and the site, and the end user can purchase the commercial products.

Further, for example, a moving image generated by the moving image generating server Sₘ can be distributed in the form of streaming or podcasting, or can be distributed through a broadcasting network, for example, for terrestrial digital TV broadcasting (one-segment broadcasting or three-segment broadcasting). Further, in the case in which it is distributed in the form of podcasting, it is possible to watch the moving image, for example, on the way to work or school, by storing the distributed moving image in a mobile terminal which can reproduce a moving image.

Further, for example, in the embodiments, contents are retrieved based on the scenario made by a third party. However, various other embodiments can be assumed for such a content retrieval. For example, URIs can be circulated by using the RSS data 1058 or the ranking retrieving data 1056, and contents can be retrieved. Furthermore, by analyzing the information based on the access ranking retrieved from a search engine (for example, contents of searches, frequency information, etc.), a list of URIs to be circulated can be formed. Contents can be retrieved based on the list.

Further, an end user can specify contents to be retrieved by the content retrieval program 30. In this case, the end user can dynamically retrieve a moving image which is requested by the end user himself.

The end user operates the home server HS₁, and requests the server Sₘ to retrieve contents, for example, based on the end user's registered scenario included in the terminal processing status data 1057. In this case, the content retrieving program 30 retrieves contents in accordance with the registered scenario.

Further, the end user operates the home server HS₁ and transmits, for example, a specific URI or a URI history stored in the browser of the home server HS₁ to the moving image generating server Sₘ. In this case, the content retrieving program 30 retrieves contents based on the URI and the URI history. Further, the URI or the URI history can be stored in the HDD 119, for example, as the user designated URI data 1053 or the user history data 1054.

Further, it is possible that the end user operates the home server HS₁ and transmits, for example, some keyword. In this case, the content retrieving program 30 operates to retrieve content of each URI managed with the keyword in the processing rule according to the keyword type 1052. Alternatively, it accesses one (or plural) search engine based on the sent keyword, and retrieves the Web content searched with the keyword at the search engine.

Further the software, which includes various types of programs and data for realizing scenario formation and moving image generation (hereinafter, written as “moving image generation authoring tool”) such as the content retrieving program 30, the moving image generating program 40, the process pattern data, and the effect process pattern data, can be implemented, for example, in the home server HS₁. In this case, an end user can operate a keyboard or a mouse while watching the display of the home server HS₁, and can generate desired moving image and watch it without referring to the moving image generating server Sₘ. Further, the moving image generation authoring tool can be implemented in the terminal device t₁₁, for example.

Further, when the scenario made by a third party 1071 is provided by a third party, the moving image generating program 40 can be configured to include an advertisement of the third party in the moving image generated by the scenario (for example, incorporate a program to combine the generated moving image with an advertisement image in the moving image generating program 40). The advertisement image can be stored in the HDD 119 in advance, or can be provided by a third party. In this case, the third party can present the advertisement to the end user as compensation for providing the scenario.

Further, in each of the embodiments described above, the content retrieving program 30 operates to retrieve the whole Web page of each URI. However, in another embodiment, the content retrieving program 30 can operate to retrieve a part of each Web page. Specifically, the content retrieving program 30 generates a request to retrieve only a specific element of a Web page based on the rule described in the content extraction rule 1060, and sends it to the Web server. The Web server extracts only the specific element based on the request, and sends the extracted data to the moving image generating server Sₘ. In this manner, the content retrieving program 30 can retrieve, for example, only the data of the specific element, and the moving image generating program 40 forms the content image which includes only the information of the specific element (for example, news information flowed on a headline), and the moving image, in which the content image is utilized, is generated.

Further, for the case in which a personal content, which requires a personal authentication (for example, transmission of a password or a cookie), is retrieved by using the moving image generating server Sₘ, the following configurations can be considered. The first one is a configuration in which storing areas for storing authentication information for each of the terminal devices t₁₁-tₓₘ (or the home servers HS₁-HSₓ) are provided in the HDD 119 of the moving image generating server Sₘ. Another one is a configuration in which each terminal device stores data for authentication in advance. And, when accessing a content which requires authentication, the terminal devices t₁₁-tₓₘ send data for authentication to the moving image generating server Sₘ, in response to the request from the moving image generating server Sₘ. With the above configurations, it is possible to generate a moving image which utilizes a personal content, which requires personal authentication. For example, when the moving image generating server Sₘ distributes the moving image, which is generated based on the scenario made by a third party 1071 (which includes retrieval of a content which requires personal authentication), to the plural terminal devices t₁₁-tₓₘ, for the contents which require personal authentication, each content is accessed by switching the authentication information for the terminal devices t₁₁-tₓₘ, respectively, and each content for the corresponding terminal only is retrieved, and each moving image for the corresponding terminal only is generated, and distributed to the corresponding terminal.

Further, in each of the embodiments described above, the Web pages are considered as the examples of Web contents and explained. However, the Web content can be, for example, a text file, or a moving image file. If the Web content is a text file, then the text file corresponding to the URI which is designated by the content retrieving program 30 is collected. Then, plural content images, including at least a part of the text in the text file, are generated, and after that, a moving image is generated using these content images. Also, if the Web content is a moving image file, then the moving image file corresponding to the URI which is designated by the content retrieving program 30 is collected and decoded, and a frame image is obtained. Then, plural content images are generated by processing the obtained at least one frame image, and after that, a moving image is generated using these content images. Namely, a Web content which is applicable to the invention is not limited to a Web page, and various other embodiments can be considered. And, as in the case of the Web page of the embodiment, Web contents of various embodiments are generated as moving images through the generating structure information determination process of FIG. 7 and the moving image generating process of FIG. 10.

Further, a content designated by a URI is not limited to a Web content, and it can be a response from a mail server, for example. For example, a mail client is implemented in the moving image generating server Sₘ, and it is confirmed whether there is an incoming mail in end user's mail box or not, by periodically accessing the mail server. The mail client can be configured in such a way that if the mail client receives a response indicating that there is an incoming call from the mail server, then the arrival of the mail is notified to the end user by superimposing a subtitle, “an mail arrived,” for example, on the moving image, by inserting a screen for indicating a message in the moving image, or by playing a sound effect or a melody. Similarly, for example, it is possible that an instant messenger is implemented in the moving image generating server Sₘ, and if a message is received, then the arrival of the message is notified to the end user by superimposing the message itself or an indication, “a message arrive,” on the moving image, or by playing a sound effect or a melody.

In the above example, the home servers HS₁-HSₓ can generate moving images. In this case, mail clients or instant messengers can be implemented in the home servers HS₁-HSₓ or each of the terminal devices t₁₁-tₓₘ. If a mail client or an instant messenger is implemented in a terminal device, then the information for notifying the end user of the arrival can be superimposed on the moving image by sending a signal representing the arrival (the text of the mail itself or the message itself can be included in the signal) from the terminal device to the home servers HS₁-HSₓ (or the moving image generating server Sₘ).

Further, in another embodiment of the invention, any kind of data format is accepted as a data format of the generated moving image, as long as the data format includes a concept of time. For example, the moving image is not limited to data consists of a group of frame images sequentially switched with respect to time such as the NTSC format, the AVI format, the MOV format, the MP4 format, and the FLV format, data which is described in a language such as SMIL (Synchronized Multimedia Integration Language) or SVG(Scalable Vector Graphics), etc., can be accepted.

Furthermore, the terminal device to reproduce the moving image is not limited to various appliances or mobile information terminals, it can be a screen located on a street or a display device placed in a compartment in a train or an airplane.

1. A moving image processing method of processing a moving image including plural flame images sequentially altering with respect to time, comprising:
an operation item setting step of setting operation items to be operated on the moving image;
a time interval setting step of setting which time interval in a reproducing period of the moving image should be defined as an interval in which the operation items that have been set are executable;
a display area setting step of setting display areas for images for operations corresponding to the operation items that have been set;
an image combining step of combining the images for operations corresponding to the operation items that have been set with the respective frame images, in accordance with the time interval setting step and the display area setting step; and
an associating step of associating, with each combined frame image, information concerning the display areas of the images for operations in the frame image and information concerning the operation items, and storing each combined frame image and the associated information.

2. The moving image processing method according to claim 1,
further comprising:
an image selecting step of selecting the images for operations displayed on the moving image; and
a process executing step of executing processes corresponding to the selected images for operations.

3. The moving image processing method according to claim 2,
wherein:
the image selecting step comprises:
a frame image specifying step of specifying, when a certain position on the moving image is selected by a user operation, the selected frame image based on timing of the selection;
a comparing step of comparing the information concerning the display area associated with the specified frame image with the information concerning the selected position; and
an image specifying step of specifying the image for the operation selected by the user operation based on the information concerning the operation items associated with the information concerning display areas, when it is determined by a result of the comparison that the selected position is contained in the display area.

4. The moving image processing method according to claim 3,
wherein:
in the above associating step, for each combined frame image, information about selectable areas in the frame image excluding the display areas for the images for operations is associated, and the associated information is stored; and
in the above comparing step, the information about selectable areas, which is associated with the specified frame image, is further compared with the information about the selected position; and
in the above image specifying step of specifying the image for the operation selected by the user operation, when it is determined that the selected position is contained in the selectable areas by the result of the comparison, it is judged that the selected position is contained in the display area.

5. The moving image processing method according to claim 2,
wherein:
in the process executing step, one of altering the display mode of the moving image, changing the position of reproduction of the moving image, switching the moving image to be reproduced, and transmitting a request to an external device, is executed in accordance with the images for the operations which have been selected in the image selecting step.

6. The moving image processing method according to claim 2,
wherein:
in the associating step, predetermined link information is further associated and is stored; and
when a predetermined image for an operation is selected in the image selecting step, then in the process executing step, a linked target is accessed by referring to the link information, and contents of the linked target is retrieved and displayed.

7. The moving image processing method according to claim 1,
wherein the operation item setting step, the time interval setting step, and the display area setting step are executed based on predetermined rules.

8. The moving image processing method according to claim 2,
wherein, when there are plural moving images to be processed, then in the associating step, moving image identifying information for identifying each moving image is further associated and stored, and in the image selecting step, the moving image containing the image for the operation selected by the user operation is specified based on the moving image identifying information.

9. The moving image processing method according to claim 1,
wherein:
plural images for operations corresponding to the operation items exist; and
in the image combining step, for the frame images corresponding to the time interval in which the operation items are executable, and for the frame images corresponding to the time interval in which the operation items are not executable, the images for operations corresponding to the different operation items are combined, respectively.

10. The moving image processing method according to claim 6,
wherein the contents include Web contents.

11. A moving image processing method of processing a moving image including plural frame images sequentially altering with respect to time, comprising:
an operation item setting step of setting operation items to be operated on the moving image;
a time interval setting step of setting which time interval in a reproducing period of the moving image should be defined as an interval in which the operation items that have been set are executable; and
an associating step of associating information about the operation items that have been set with each frame image corresponding to the time interval that has been set, and storing the associated information.

12. The moving image processing method according to claim 11,
further comprising:
a frame image specifying step of specifying a frame image corresponding to a timing of a click when a part of the moving image is clicked by a user operation, based on the timing in which the click is made; and
a process executing step for executing processes corresponding to the information about the operation items which has been associated with the specified frame image.

13. The moving image processing method according to claim 11,
further comprising:
an image effect adding step of adding effects, which designate that the operation items are executable, to the frame images corresponding to the time interval that has been set or a time interval having a predetermined relationship with the time interval that has been set.

14. The moving image processing method according to claim 11,
further comprising:
an audio effect adding step of adding predetermined audios to the moving image or adding predetermined effects to audios associated with the moving image, in the time interval that has been set or in the time interval having a predetermined relationship with the time interval that has been set.

15. A moving image processing method of processing a moving image including plural frame images sequentially altering with respect to time, comprising:
a moving image generating step of generating a moving image based on contents;
an operation item setting step of setting operation items to be operated on the generated moving image;
a time interval setting step of setting which time interval in a reproducing period of the moving image should be defined as an interval in which the operation items that have been set are executable;
a display area setting step of setting display areas for images for operations corresponding to the operation items that have been set;
an image combining step of combining the operation images corresponding to the operation items that have been set with the respective frame images, in accordance with settings by the time interval setting step and the display area setting step; and
an associating step of associating, with each combined frame image, information concerning the display areas of the images for operations in the frame image and information concerning the operation items, and storing each combined frame image and the associated information.

16. The moving image processing method according to claim 15,
wherein:
the moving image generating step comprises:
a content designating step of designating plural contents used for the moving image;
a content collecting step of collecting each designated content;
a content image generating step of generating content images based on the collected contents;
a display mode setting step of setting a mode for displaying each generated content image; and
a generating step of generating the moving image such that each content image is changed in a chronological order based on the display mode that has been set.

17. The moving image processing method according to claim 15,
wherein the contents includes information that can be displayed.

18. The moving image processing method according to claim 15,
wherein the contents include Web contents.

19. The moving image processing method according to claim 18,
wherein:
the Web contents are Web pages; and
in the content image generating step, the collected Web pages are analyzed, and the content images are generated based on a result of the analysis.

20. (canceled)

21. A moving image processing device for processing a moving image including plural flame images sequentially altering with respect to time, comprising:
an operation item setting unit that sets operation items to be operated on the moving image;
a time interval setting unit that sets which time interval in a reproducing period of the moving image should be defined as an interval in which the operation items that have been set are executable;
a display area setting unit that sets display areas for images for operations corresponding to the operation items that have been set;
an image combining unit that combines the operation images corresponding to the operation items that have been set with the respective frame images, in accordance with the settings of the time interval setting unit and the display area setting unit; and
an associating unit that associates, with each combined frame image, information concerning the display areas of the images for operations in the frame image and information concerning the operation items, and stores each combined frame image and the associated information.

22. The moving image processing device according to claim 21,
further comprising:
an image selecting unit that selects the images for the operations displayed on the moving image, and
a process executing unit that executes processes corresponding to the selected images for the operations.

23. The moving image processing device according to claim 22,
wherein the image selecting unit is configured such that:
when a certain position on the moving image is selected by a user operation, the selected frame image is specified based on timing of the selection;
the information about the display area which is associated with the specified frame image and the information about the selected position are compared; and
when it is judged by a result of the comparison that the selected position is contained in the display area, the images for the operations that have been selected by the user operation are specified based on the information about the operation items which is associated with the information about the display area.

24. The moving image processing device according to claim 23,
wherein:
the associating unit is configured such that for each combined frame image, information about selectable areas in the frame image excluding the display areas for the images for operations is associated, and the associated information is stored;
the comparing unit further compares the information about selectable areas which is associated with the specified frame image with the information about the selected position; and
the image selecting unit determines that the selected position is contained in the display area when it is determined by a result of the comparison that the selected position is contained in the selectable areas.

25. The moving image processing device according to claim 22,
wherein the process executing unit is configured to execute one of altering the display mode of the moving image, changing the position of reproduction of the moving image, switching the moving image, and transmitting a request to an external device in accordance with the images for the operations which have been selected by the image selecting unit.

26. The moving image processing device according to claim 22,
wherein:
the associating unit further associates predetermined link information and stores the information;
when a predetermined image for an operation is selected by the image selecting unit, the process executing unit refers to the link information and accesses a linked target, and the process executing unit retrieves contents on the linked target and displays the contents.

27. The moving image processing device according to claim 21,
further comprising:
a storing unit that stores setting rules of setting operation items to be operated on the moving image, setting a time interval in which the operation items are executable, and setting display areas for the operation items,
wherein the operation item setting unit, the time interval setting unit, and the display area setting unit are configured to execute setting process based on the setting rules.

28. The moving image processing device according to claim 22,
wherein when plural images to be processed exist, then the associating unit associates moving image identifying information for identifying each moving image and stores the associated moving image identifying information, and the image selecting unit specifies the moving image containing the image for the operation selected by the user operation, based on the moving image identifying information.

29. The moving image processing device according to claim 21,
wherein:
plural images for operations corresponding to the operation items exist;
the combining unit combines, with the frame images corresponding to the time interval in which the operation items are executable and the frame images corresponding to the time interval in which the operation items are not executable, the images for operations corresponding to the different operation items, respectively.

30. The moving image processing device according to claim 26,
wherein the contents include Web contents.

31. A moving image processing device for processing a moving image including plural frame images sequentially altering with respect to time, comprising:
an operation item setting unit that sets operation items to be operated on the moving image;
a time interval setting unit that sets which time interval in a reproducing period of the moving image should be defined as an interval in which the operation items that have been set are executable; and
an associating unit that associates each frame image corresponding to the time interval that has been set with the information about the operation items that have been set.

32. The moving image processing device according to claim 31,
further comprising:
a frame image specifying unit that specifies a frame image corresponding to a timing of a click, when a part of the moving image is clicked by a user operation, based on the timing in which the click is made; and
a process executing unit that executes processes corresponding to the information about the operation items which has been associated with the specified frame image.

33. The moving image processing device according to claim 31,
further comprising:
an image effect adding unit that adds effects, which designate that the operation items are executable, to the frame images corresponding to the time interval that has been set or a time interval having a predetermined relationship with the time interval that has been set.

34. The moving image processing device according to claim 31,
further comprising:
an audio effect adding unit that adds predetermined audios to the moving image or adds predetermined effects to audios associated with the moving image, in the time interval that has been set or in the time interval having a predetermined relationship with the time interval that has been set.

35. A moving image processing device for processing a moving image including plural flame images sequentially altering with respect to time, comprising:
a moving image generating unit that generates a moving image based on contents; an operation item setting unit that sets operation items to be operated on the generated moving image;
a time interval setting unit that sets which time interval in a reproducing period of the moving image should be defined as an interval in which the operation items that have been set are executable;
a display area setting unit that sets display areas for images for operations corresponding to the operation items that have been set;
an image combining unit that combines the operation images corresponding to the operation items that have been set with the respective frame images, in accordance with the settings of the time interval setting unit and the display area setting unit; and
an associating unit that associates, with each combined frame image, information concerning the display areas of the images for operations in the frame image and information concerning the operation items, and stores each combined frame image and the associated information.

36. The moving image processing device according to claim 35,
further comprising:
a content designating unit that designates plural contents used for the moving image;
a content collecting unit that collects each designated content;
a content image generating unit that generates content images based on the collected contents; and
a display mode setting unit that sets a mode for displaying each generated content image,
wherein the moving image generating unit generates a moving image in which each content image sequentially changes with respect to time based on the display mode which has been set.

37. The moving image processing device according to claim 35,
wherein the contents include information which can be displayed.

38. The moving image processing device according to according to claim 35, wherein the contents include Web contents.

39. The moving image processing device according to claim 38,
wherein:
the Web contents are Web pages; and
the content image generating unit analyzes the collected Web pages, and generates the content images based on a result of the analysis.

40. A computer-readable medium having computer readable instruction stored thereon, which, when executed by a processor of a device for processing a moving image including plural flame images sequentially altering with respect to time, configures the processor to perform:
an operation item setting step of setting operation items to be operated on the moving image;
a time interval setting step of setting which time interval in a reproducing period of the moving image should be defined as an interval in which the operation items that have been set are executable;
a display area setting step of setting display areas for images for operations corresponding to the operation items that have been set;
an image combining step of combining the images for operations corresponding to the operation items that have been set with the respective frame images, in accordance with the time interval setting step and the display area setting step; and
an associating step of associating, with each combined frame image, information concerning the display areas of the images for operations in the frame image and information concerning the operation items, and storing each combined frame image and the associated information.

41. A computer-readable medium having computer readable instruction stored thereon, which, when executed by a processor of a device for processing a moving image including plural flame images sequentially altering with respect to time, configures the processor to perform:
an operation item setting step of setting operation items to be operated on the moving image;
a time interval setting step of setting which time interval in a reproducing period of the moving image should be defined as an interval in which the operation items that have been set are executable; and
an associating step of associating information about the operation items that have been set with each frame image corresponding to the time interval that has been set, and storing the associated information.

42. A computer-readable medium having computer readable instruction stored thereon, which, when executed by a processor of a device for processing a moving image including plural flame images sequentially altering with respect to time, configures the processor to perform:
a moving image generating step of generating a moving image based on contents;
an operation item setting step of setting operation items to be operated on the generated moving image;
a time interval setting step of setting which time interval in a reproducing period of the moving image should be defined as an interval in which the operation items that have been set are executable;
a display area setting step of setting display areas for images for operations corresponding to the operation items that have been set;
an image combining step of combining the operation images corresponding to the operation items that have been set with the respective frame images, in accordance with settings by the time interval setting step and the display area setting step; and
an associating step of associating, with each combined frame image, information concerning the display areas of the images for operations in the frame image and information concerning the operation items, and storing each combined frame image and the associated information.
